(19) United States
(12) Patent Application Publication
(10) Pub. No.: US 2012/0121019 A1
(43) Pub. Date: May 17, 2012

(54) IMAGE PROCESSING DEVICE AND METHOD

(76) Inventor: Kazushi Sato, Kanagawa (JP)

(21) Appl. No.: 13/264,242

(22) PCT Filed: Apr. 22, 2010
(86) PCT No.: PCT/JP2010/057128

§ 371 Date: Dec. 9, 2011

(30) Foreign Application Priority Data
Apr. 24, 2009 (JP) 2009-105938

(51) Int. Cl. H04N 7/32

(52) U.S. Cl. 375/240.16; 375/240.12; 375/E07.123; 375/E07.243

(57) ABSTRACT

The present invention relates to an image processing device and method enabling second order prediction to be performed even in the event that adjacent pixels adjacent to a reference block exist outside an image frame.

A reference adjacent pixel determining unit 83 receives input of determination results from a reference adjacent determining unit 77 regarding whether or not reference adjacent pixels exist within the image frame of a reference frame. In the event that reference adjacent pixels exist within the image frame of the reference frame, the reference adjacent pixel determining unit 83 determines the pixel values of the adjacent pixels based on the definition of the H.264/AVC format. On the other hand, in the event that reference adjacent pixels do not exist within the image frame of the reference frame, the reference adjacent pixel determining unit 83 determines the pixel values of the reference adjacent pixels by performing terminal point processing regarding the non-existent adjacent pixels. The present invention can be applied to an image encoding device which encodes with the H.264/AVC format, for example.

### TECHNICAL FIELD

The present invention relates to an image processing device and method, and more particularly relates to an image processing device and method which enable secondary prediction to be performed in cases where an adjacent pixel adjacent to a reference block exists outside an image frame, as well.

### BACKGROUND ART

In recent years, there have been spreading devices which subject an image to compression encoding by employing an encoding system for handling image information as digital signals, and taking advantage of redundancy peculiar to the image information, aiming for transmission and storage of high effective information at that time, to compress the image by orthogonal transform such as discrete cosine transform or the like and motion compensation. Examples of this encoding method include MPEG (Moving Picture Expert Group) and so forth.

In particular, MPEG2 (ISO/IEC 13818-2) is defined as a general-purpose image encoding format, and is a standard encompassing both of interlaced scanning images and sequential-scanning images, and standard resolution images and high definition images. For example, MPEG2 has widely been employed now by broad range of applications for professional usage and for consumer usage. By employing the MPEG2 compression format, a code amount (bit rate) of 4 through 8 Mbps is allocated in the case of an interlaced scanning image of standard resolution having 720×480 pixels, for example. By employing the MPEG2 compression format, a code amount (bit rate) of 18 through 22 Mbps is allocated in the case of an interlaced scanning image of high resolution having 1920×1088 pixels, for example. Thus, high compression rate and excellent image quality can be realized.

With MPEG2, high image, quality encoding adapted to broadcasting usage is principally taken as a object, but a lower code amount (bit rate) than the code amount of MPEG1, i.e., an encoding format having a higher compression rate is not handled. Due to personal digital assistants becoming widespread, it has been expected that needs for such an encoding format will increase from now on, and in response to this, the MPEG4 encoding format has been standardized. With regard to an image encoding format, the specification thereof was confirmed as international standard as ISO/IEC 14496-2 in December in 1998.

Further, in recent years, standardization of a standard serving as H.26L (ITU-T Q6/16 VCEG) has progressed with image encoding for television conference usage taken as an object. With H.26L, it has been known that as compared to a conventional encoding format such as MPEG2 or MPEG4, though greater computation amount is requested for encoding and decoding thereof, higher encoding efficiency is realized. Also, currently, as part of activity of MPEG4, standardization for taking advantage of a function that is not supported by H.26L with this H.26L taken as base to realize higher encoding efficiency has been performed as Joint Model of Enhanced-Compression Video Coding. As for the schedule of standardization, H.264 and MPEG-4 Part10 (Advanced Video Coding, hereafter referred to as H.264/AVC) became an international standard in March, 2003.

Further, as an expansion thereof, standardization of FRExt (Fidelity Range Extension), which includes encoding tools necessary for operations such as RGB, 4:2:2, 4:4:4, and so forth, and MPEG-2 stipulated 8×8DCT and quantization matrices, was completed in February of 2005. Accordingly, an encoding format capable of expressing well film noise included in movies using H.264/AVC was obtained, and is to be used in a wide range of applications such as Blu-Ray Disc (Registered Trademark).

However, as of recent, there are increased needs for even further high compression encoding, such as to compress images around 4000×2000 pixels, which is fourfold that of Hi-Vision images. Also, there are needs for even further high compression encoding, such as to distribute Hi-Vision images in an environment with limited transmission capacity, such as the Internet. Accordingly, the VCEG (=Video Coding Expert Group) under the ITU-T, described above, is continuing study relating to improved encoding efficiency.

For example, in NPL 1, a second order prediction method is proposed for further improving encoding efficiency in inter prediction. This second order prediction method will be described with reference to FIG. 1.

A current frame and reference frame are shown in the example in FIG. 1, with a current block A shown in the current frame.

In the event that a motion vector mv (mv_x, mv_y) as to the current block A is obtained in the reference frame and current frame, difference information (residual) between the current block A and a block B correlated as to the current block A by the vector mv, is calculated.

With the second order method, not only difference information relating to he current block A, but also difference information between an adjacent pixel group A′ adjacent to the current block A an adjacent pixel group B′ correlated as to the adjacent pixel group A′ by the vector mv, is calculated.

That is to say, the addresses of each of the pixels of the adjacent pixel group A′ are obtained from the upper left address (x, y) of the current block A. Also, the addresses of each of the pixels of the adjacent pixel group B′ are calculated from the upper left address (x+mv_x, y+mv_y) of the block B correlated with the current block A with the motion vector mv (mv_x, mv_y). These addresses are used to calculate the difference information of the adjacent pixel group B′.

With the second order method, intra prediction according to the H.264/AVC method is performed between difference information relating to the current block calculated in this way, and difference information relating to adjacent pixels, thereby generating second order difference information. The generated second order difference information is subjected to orthogonal transform and quantization, is encoded along with the compressed image, and sent to the decoding side.

### CITATION LIST

### Non Patent Literature

NPL 1: “Second Order Prediction (SOP) in P Slice”, Sijia Chen, JinpengWang, Shangwen Li and, Lu Yu, VCEG-AD09, ITU-Telecommunications Standardization Sector STUDY GROUP Question 6 Video coding Experts Group(VCEG), 16-18 Jul. 2008

### SUMMARY OF INVENTION

### Technical Problem

Now, while the current block A always exists within the image frame of the current frame, whether or not the reference block B exists within the image frame of the reference frame depends on the address of the current block A and the value of the motion vector.

For example, in the example in FIG. 2, motion vectors mv1 and mv2 regarding the current block A are detected in the reference frame. The reference block B1 correlated with the current block A by the motion vector mv1 has a part thereof protruding out from the lower portion of the image frame, and accordingly, the adjacent pixel group B1′ adjacent to the reference block B1 also has a part thereof protruding out from the lower portion of the image frame.

Also, the reference block B2 correlated with the current block A by the motion vector mv2 is within the image frame, but the adjacent pixel group B2′ adjacent to the reference block B2 has a part thereof protruding out from the right portion of the image frame.

That is to say, not only whether or not the reference block exists within the image frame, but also whether or not the adjacent pixel group adjacent to the reference block exists within the image frame depends on the address of the current block A and the value of the motion vector. Pixels which doe not exist within the image frame in this way as taken as not being available “available” as reference pixels.

Thus, in the event of applying the second order prediction method described in NPL 1, there are cases wherein adjacent pixels adjacent to the reference blocks are not available, and in such cases, it has been difficult to perform second order prediction.

That is, with the second order prediction method described in NPL 1, H.264/AVC format intra prediction is diverted to second order prediction. With H.264/AVC format intra prediction, there is no need to perform determination of the availability of adjacent pixels, so H.264/AVC format intra prediction could not be diverted to determination of the availability of adjacent pixels for second order prediction.

Accordingly, with second order prediction, there has been the need to add a circuit relating to just determination of the availability of adjacent pixels.

The present invention has been made in light of such a situation, and is to enable second order prediction even in cases where adjacent pixels adjacent to the reference blocks exist outside of the image frame as well.

### Solution to Problem

An image processing device according to a first aspect of the present invention includes: determining means for determining, using a relative address of a current adjacent pixel which is adjacent to a current block in a current frame, whether or not a reference adjacent pixel adjacent to a reference block in the reference frame exists within an image frame of the reference frame; terminal point processing means for performing terminal point processing as to the reference adjacent pixel in the event that determination is made by the determining means that the reference adjacent pixel does not exist within the image frame; second order prediction means for generating second order different information, by performing prediction between difference information between the current block and the reference block, and difference information between the current adjacent pixel and the reference adjacent pixel regarding which terminal point processing has been performed by the terminal point processing means; and encoding means for encoding the second order different information generated by the second order prediction means.

The image processing device may further include calculating means for calculating a relative address (x+dx+δx, y+dy+δy) of the reference adjacent pixel, with an address (x, y) of the current block, motion vector information (dx, dy) by which the current block refers to the reference block, and a relative address (δx, δy) of the current adjacent pixel, with the determining means determine whether or not the relative address (x+dx+δx, y+dy+δy) of the reference adjacent pixel calculated by the calculating means exists within the image frame.

In the event that pixel values are represented as n bits, the terminal point processing means may perform the terminal point processing such that the pixel value of the reference adjacent pixel regarding which

x+dx+δx<0 or y+dy+δy<0

holds is 2ⁿ⁻¹.

The terminal point processing means may perform the terminal point processing using a pixel value pointed to by an address (WIDTH−1, y+dy+δy) as the pixel value of the reference adjacent pixel in the event that

x+dx+δx>WIDTH−1

holds, where WIDTH represents the number of pixels in the horizontal direction of the image frame.

The terminal point processing means may perform the terminal point processing using a pixel value pointed to by an address (x+dx+δx, HEIGHT−1) as the pixel value of the reference adjacent pixel in the event that

y+dy+δy>HEIGHT−1

holds, where HEIGHT represents the number of pixels in the vertical direction of the image frame.

The terminal point processing means may perform the terminal point processing using a pixel value pointed to by an address (WIDTH−1, HEIGHT−1) as the pixel value of the reference adjacent pixel in the event that

x+dx+δx>WIDTH−1 and y+dy+δy>HEIGHT−1

hold, where WIDTH represents the number of pixels in the horizontal direction of the image frame and HEIGHT represents the number of pixels in the vertical direction of the image frame.

The terminal point processing means may perform the terminal point processing in which pixel values are generated by mirror processing, symmetrically at the boundary of the image frame as to the reference adjacent pixels not existent in the image frame.

The second order prediction means may further include: intra prediction means for performing prediction using difference information between the current adjacent pixel and the reference adjacent pixel regarding which terminal processing has been performed by the terminal point processing means, to generate an intra prediction image as to the current block; and second order difference generating means for differencing the difference information between the current block and the reference block, and the intra prediction image generated by the intra prediction means, to generate the second order difference information.

In the event that the determining means determine that the reference adjacent pixel exists within the image frame, the second order prediction means may perform prediction between difference information between the current block and the reference block, and difference information between the current adjacent pixel and the reference adjacent pixel.

An image processing method according to the first aspect of the present invention includes the step of: an image processing device determining, using a relative address of a current adjacent pixel which is adjacent to a current block in a current frame, whether or not a reference adjacent pixel adjacent to a reference block in the reference frame exists within an image frame of the reference frame, performing terminal point processing as to the reference adjacent pixel in the event that determination is made that the reference adjacent pixel does not exist within the image frame, generating second order different information, by performing prediction between difference information between the current block and the reference block, and difference information between the current adjacent pixel and the reference adjacent pixel regarding which terminal point processing has been performed, and encoding the generated second order different information.

An image processing device according to a second aspect of the present invention includes: decoding means for decoding an image of a current block in an encoded current frame; determining means for determining, using a relative address of a current adjacent pixel which is adjacent to the current block, whether or not a reference adjacent pixel adjacent to a reference block in the reference frame exists within an image frame of the reference frame; terminal point processing means for performing terminal point processing as to the reference adjacent pixel in the event that determination is made by the determining means that the reference adjacent pixel does not exist within the image frame; second order prediction means for generating a prediction image, by performing second order prediction using difference information between the current adjacent pixel and the reference adjacent pixel regarding which terminal processing has been performed by the terminal point processing means; and computing means for adding the image of the current block, the prediction image generated by the second order prediction means, and the image of the reference block, to generate a decoded image of the current block.

The image processing device may further include calculating means for calculating a relative address (x+dx+δx, y+dy+δy) of the reference adjacent pixel, with an address (x, y) of the current block, motion vector information (dx, dy) by which the current block refers to the reference block, and a relative address (δx, δy) of the current adjacent pixel; with the determining means determining whether or not the relative address (x+dx+δx, y+dy+δy) of the reference adjacent pixel calculated by the calculating means exists within the image frame.

In the event that pixel values are represented as n bits, the terminal point processing means may perform terminal point processing such that the pixel value of the reference adjacent pixel regarding which

x+dx+δx<0 or y+dy+δy<0

holds is 2ⁿ⁻¹.

The terminal point processing means may perform the terminal point processing using a pixel value pointed to by an address (WIDTH−1, y+dy+δy) as the pixel value of the reference adjacent pixel in the event that

x+dx+δx>WIDTH−1

holds, where WIDTH represents the number of pixels in the horizontal direction of the image frame.

The terminal point processing means may perform the terminal point processing using a pixel value pointed to by an address (x+dx+δx, HEIGHT−1) as the pixel value of the reference adjacent pixel in the event that

y+dy+δy>HEIGHT−1

holds, where HEIGHT represents the number of pixels in the vertical direction of the image frame.

The terminal point processing means may perform the terminal point processing using a pixel value pointed to by an address (WIDTH−1, HEIGHT−1) as the pixel value of the reference adjacent pixel in the event that

x+dx+δx>WIDTH−1 and y+dy+δy>HEIGHT−1

hold, where WIDTH represents the number of pixels in the horizontal direction of the image frame and HEIGHT represents the number of pixels in the vertical direction of the image frame.

The terminal point processing means may perform the terminal point processing in which pixel values are generated by mirror processing, symmetrically at the boundary of the image frame as to the reference adjacent pixels not existent in the image frame.

The second order prediction means may further include: prediction image generating means for generating a prediction image by performing second order prediction using difference information between the current adjacent pixel and the reference adjacent pixel regarding which terminal processing has been performed by the terminal point processing means.

In the event that the determining means determine that the reference adjacent pixel exists within the image frame, the second order prediction means may perform prediction using difference information between the current adjacent pixel and the reference adjacent pixel.

An image processing method according to the second aspect of the present invention includes the step of: an image processing device decoding an image of a current block in an encoded current frame, determining, using a relative address of a current adjacent pixel which is adjacent to the current block, whether or not a reference adjacent pixel adjacent to a reference block in the reference frame exists within an image frame of the reference frame, performing terminal point processing as to the reference adjacent pixel in the event that determination is made that the reference adjacent pixel does not exist within the image frame, generating a prediction image, by performing second order prediction using difference information between the current adjacent pixel and the reference adjacent pixel regarding which terminal processing has been performed, and adding the image of the current block, the prediction image generated by the second order prediction means, and the image of the reference block, to generate a decoded image of the current block.

With the first aspect of the present invention, whether or not a reference adjacent pixel adjacent to a reference block in a reference frame exists within an image frame of the reference frame is determined, using a relative address of a current adjacent pixel which is adjacent to a current block in a current frame. In the event that determination is made that the reference adjacent pixel does not exist within the image frame, terminal point processing is performed as to the reference adjacent pixel, second order different information is generated by performing prediction between difference information between the current block and the reference block, and difference information between the current adjacent pixel and the reference adjacent pixel regarding which terminal point processing has been performed, and the generated second order different information is encoded.

With the second aspect of the present invention, an image of a current block in an encoded current frame is decoded, and whether or not a reference adjacent pixel adjacent to a reference block in the reference frame exists within an image frame of the reference frame is determined, using a relative address of a current adjacent pixel which is adjacent to a current block in a current frame. In the event that determination is made that the reference adjacent pixel does not exist within the image frame, terminal point processing is performed as to the reference adjacent pixel, second order different information is generated by performing prediction between difference information between the current block and the reference block, and difference information between the current adjacent pixel and the reference adjacent pixel regarding which terminal point processing has been performed, and the image of the current block, the prediction image generated by the second order prediction means, and the image of the reference block, are added to generate a decoded image of the current block.

Note that each of the above-described image processing devices may be independent devices, or may be internal blocks making up a single image encoding device or image decoding device.

### Advantageous Effects of Invention

According to the first aspect of the present invention, an image can be encoded. Also, according to the first aspect of the present invention, second order prediction can be performed even in the event that an adjacent pixel adjacent to a reference block exists outside of the image frame.

According to the second aspect of the present invention, an image can be decoded. Also, according to the second aspect of the present invention, second order prediction can be performed even in the event that an adjacent pixel adjacent to a reference block exists outside of the image frame.

### BRIEF DESCRIPTION OF DRAWINGS

FIG. 1 is a diagram describing a second order prediction system in inter prediction.

FIG. 2 is a diagram describing adjacent pixel groups adjacent to reference blocks.

FIG. 3 is a block diagram illustrating the configuration of an embodiment of an image encoding device to which the present invention has been applied.

FIG. 4 is a diagram for describing variable block size motion prediction and compensation processing.

FIG. 5 is a diagram for describing motion prediction and compensation processing with ¼ pixel precision.

FIG. 6 is a diagram for describing a motion prediction and compensation method of multi-reference frames.

FIG. 7 is a diagram for describing an example of a motion vector information generating method.

FIG. 8 is a block diagram illustrating a configuration example of a second order prediction unit in FIG. 3.

FIG. 9 is a diagram for describing operations of the second order prediction unit an a reference adjacent determining unit.

FIG. 10 is a diagram for describing setting, of reference adjacent pixels.

FIG. 11 is a diagram for describing setting of reference adjacent pixels.

FIG. 12 is a diagram for describing an example of terminal point processing.

FIG. 13 is a flowchart for describing the encoding processing of the image encoding device in FIG. 3.

FIG. 14 is a flowchart for describing the prediction processing in step S21 in FIG. 13.

FIG. 15 is a diagram for describing processing sequence in the event of a 16×16-pixel intra prediction mode.

FIG. 16 is a diagram illustrating the kinds of 4×4-pixel intra prediction modes for luminance signals.

FIG. 17 is a diagram illustrating the kinds of 4×4-pixel intra prediction modes for luminance signals.

FIG. 18 is a diagram for describing the direction of 4×4-pixel intra prediction.

FIG. 19 is a diagram for describing 4×4-pixel intra prediction.

FIG. 20 is a diagram for describing encoding of the 4×4-pixel intra prediction modes for luminance signals.

FIG. 21 is a diagram illustrating the kinds of 8×8-pixel intra prediction modes for luminance signals.

FIG. 22 is a diagram illustrating the kinds of 8×8-pixel intra prediction modes for luminance signals.

FIG. 23 is a diagram illustrating the kinds of 16×16-pixel intra prediction modes for luminance signals.

FIG. 24 is a diagram illustrating the kinds of 16×16-pixel intra prediction modes for luminance signals.

FIG. 25 is a diagram for describing 16×16-pixel intra prediction.

FIG. 26 is a diagram illustrating the kinds of intra prediction modes for color difference signals.

FIG. 27 is a flowchart for describing the intra prediction processing in step S31 in FIG. 14.

FIG. 28 is a flowchart for describing the inter motion prediction processing in step S32 in FIG. 14.

FIG. 29 is a flowchart for describing the reference adjacent pixel determining processing in step S53 in FIG. 28.

FIG. 30 is a flowchart for describing the second order prediction processing in step S54 in FIG. 28.

FIG. 31 is a block diagram illustrating the configuration example of an embodiment of an image decoding device to which the present invention has been applied.

FIG. 32 is a block diagram illustrating a configuration example of a second order prediction unit in FIG. 31.

FIG. 33 is a flowchart for describing the decoding processing of the image decoding device in FIG. 31.

FIG. 34 is a flowchart for describing the prediction processing in step S138 in FIG. 33.

FIG. 35 is a flowchart for describing the second order inter prediction processing in step S179 in FIG. 34.

FIG. 36 is a block diagram illustrating a configuration example of the hardware of a computer.

### DESCRIPTION OF EMBODIMENTS

Hereafter, an embodiment of the present invention will be described with reference to the drawings.

### [Configuration Example of Image Encoding Device]

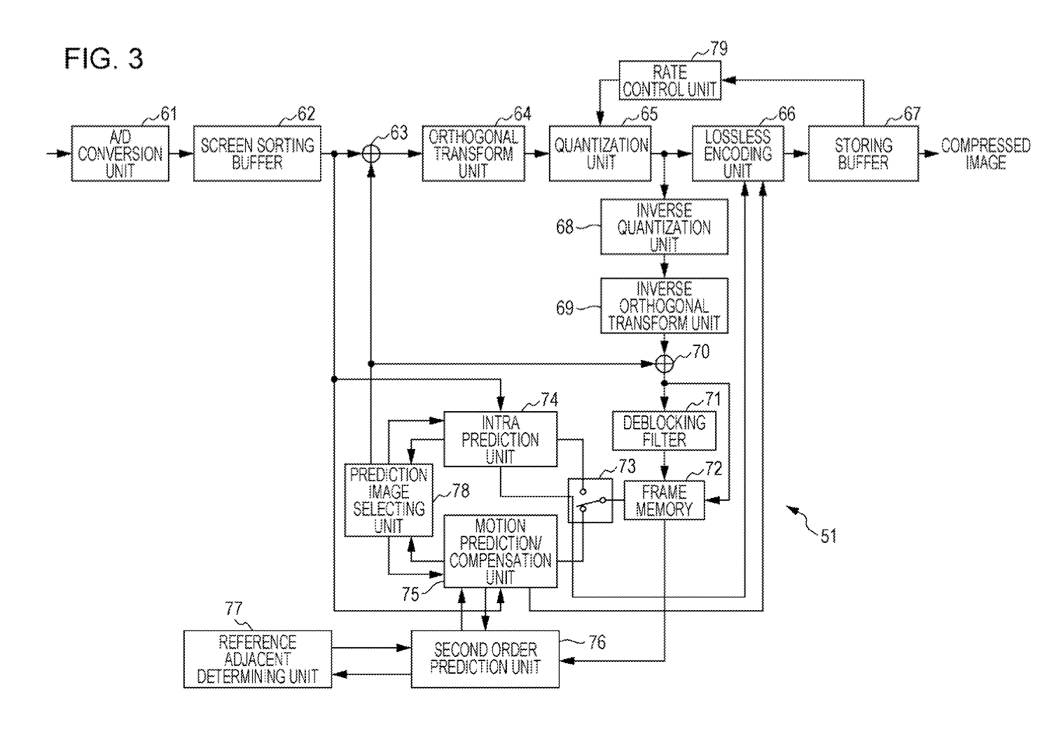

FIG. 3 represents the configuration of an embodiment of an image encoding device serving as an image processing device to which the present invention has been applied.

This image encoding device 51 subjects an image to compression encoding using, for example, the H.264 and MPEG-4 Part10 (Advanced Video Coding) (hereafter, described as 264/AVC) format.

With the example in FIG. 3, the image encoding device 51 is configured of an A/D conversion unit 61, a screen sorting buffer 62, a computing unit 63, an orthogonal transform unit 64, a quantization unit 65, a lossless encoding unit 66, an storing buffer 67, an inverse quantization unit 68, an inverse orthogonal transform unit 69, a computing unit 70, a deblocking filter 71, frame memory 72, a switch 73, an intra prediction unit 74, a motion prediction/compensation unit 75, a second order prediction unit 76, a reference adjacent determining unit 77, a prediction image selecting unit 78, and a rate control unit 79.

The A/D conversion unit 61 converts an input image from analog to digital, and outputs to the screen sorting buffer 62 for storing. The screen sorting buffer 62 sorts the images of frames in the stored order for display into the order of frames for encoding according to GOP (Group of Picture).

The computing unit 63 subtracts from the image read out from the screen sorting buffer 62 the prediction image from the intra prediction unit 74 selected by the prediction image selecting unit 78 or the prediction image from the motion prediction/compensation unit 75, and outputs difference information thereof to the orthogonal transform unit 64. The orthogonal transform unit 64 subjects the difference information from the computing unit 63 to orthogonal transform, such as discrete cosine transform, Karhunen-Loéve transform, or the like, and outputs a transform coefficient thereof. The quantization unit 65 quantizes the transform coefficient that the orthogonal transform unit 64 outputs.

The quantized transform coefficient that is the output of the quantization unit 65 is input to the lossless encoding unit 66, and subjected to lossless encoding, such as variable length coding, arithmetic coding, or the like, and compressed.

The lossless encoding unit 66 obtains information indicating intra prediction from the intra prediction unit 74, and obtains information indicating an inter prediction mode, and so forth from the motion prediction/compensation unit 75. Note that the information indicating intra prediction and the information indicating inter prediction will hereafter be referred to as intra prediction mode information and inter prediction mode information, respectively.

The lossless encoding unit 66 encodes the quantized transform coefficient, and also encodes the information indicating intra prediction, the information indicating an inter prediction mode, and so forth, and takes these as part of header information in the compressed image. The lossless encoding unit 66 supplies the encoded data to the storing buffer 67 for storage.

For example, with the lossless encoding unit 66, lossless encoding processing, such as variable length coding, arithmetic coding, or the like, is performed. Examples of the variable length coding include CAVLC (Context-Adaptive Variable Length Coding) determined by the H.264/AVC format. Examples of the arithmetic coding include CABAC (Context-Adaptive Binary Arithmetic Coding).

The storing buffer 67 outputs the data supplied from the lossless encoding unit 66 to, for example, a storage device or transmission path or the like downstream not shown in the drawing, as a compressed image encoded by the H.264/AVC format.

Also, the quantized transform coefficient output from the quantization unit 65 is also input to the inverse quantization unit 68, subjected to inverse quantization, and then subjected to further inverse orthogonal transform at the inverse orthogonal transform unit 69. The output subjected to inverse orthogonal transform is added to the prediction image supplied from the prediction image selecting unit 78 by the computing unit 70, and changed into a locally decoded image. The deblocking filter 71 removes block noise from the decoded image, and then supplies to the frame memory 72 for storage. An image before the deblocking filter processing is performed by the deblocking filter 71 is also supplied to the frame memory 72 for storage.

The switch 73 outputs the reference images stored in the frame memory 72 to the motion prediction/compensation unit 75 or intra prediction unit 74.

With this image encoding device 51, the I picture, B picture, and P picture from the screen sorting buffer 62 are supplied to the intra prediction unit 74 as an image to be subjected to intra prediction (also referred to as intra processing), for example. Also, the B picture and P picture read out from the screen sorting buffer 62 are supplied to the motion prediction/compensation unit 75 as an image to be subjected to inter prediction (also referred to as inter processing).

The intra prediction unit 74 performs intra prediction processing of all of the intra prediction modes serving as candidates based on the image to be subjected to intra prediction read out from the screen sorting buffer 62, and the reference image supplied from the frame memory 72 to generate a prediction image.

At this time, the intra prediction unit 74 calculates a cost function value as to all candidate intra prediction modes, and selects the intra prediction mode where the calculated cost function value gives the minimum value, as the optimal intra prediction mode.

The intra prediction unit 74 supplies the prediction image generated in the optimal intra prediction mode and the cost function value thereof to the prediction image selecting unit 78. In the event that the prediction image generated in the optimal intra prediction mode has been selected by the prediction image selecting unit 78, the intra prediction unit 74 supplies information indicating the optimal intra prediction mode to the lossless encoding unit 66. The lossless encoding unit 66 encodes this information so as to be taken as a part of the header information in the compressed image.

The motion prediction/compensation unit 75 performs motion prediction and compensation processing regarding all of the inter prediction modes serving as candidates. Specifically, the image to be subjected to inter processing read out from the screen sorting buffer 62 is supplied as to the motion prediction/compensation unit 75, as well as the reference image being supplied thereto from the frame memory 72 via the switch 73. The motion prediction/compensation unit 75 detects the motion vectors of all of the inter prediction modes serving as candidates based on the image to be subjected to inter processing and the reference image, subjects the reference image to compensation processing based on the motion vectors, and generates a prediction image.

The motion prediction/compensation unit 75 supplies, to the second order prediction unit 76, the detected motion vector information, information of the image for inter processing (address, etc.), and first order residual which is the residual between the image to be subjected to inter processing and the generated prediction image.

The second order prediction unit 76 obtains the addresses of reference adjacent pixels adjacent to a reference block correlated with the current block using the motion vector information, and supplies to the reference adjacent determining unit 77. In accordance with the determination results from the reference adjacent determining unit 77 input in accordance with this, the second order prediction unit 75 performs terminal point processing, with corresponding pixels being read out from the frame memory 72 and subjected to second order prediction processing. Note that terminal point processing is processing for determining a pixel value used for a reference adjacent pixel found to be outside of the image frame of the reference frame, using another pixel value existing within the image frame. Also, second order prediction is processing for performing prediction between first order residual and the difference between a current adjacent pixel and a reference adjacent pixel, and generating second order difference information (second order residual).

The second order prediction unit 76 outputs the second order residual generated by the second order prediction processing, and the information of the intra prediction mode used for the second order prediction processing, to the motion prediction/compensation unit 75 as intra prediction mode information in second order prediction.

The reference adjacent determining unit 77 uses the address of the reference adjacent pixel from the motion prediction/compensation unit 75 to determine whether or not the reference adjacent pixel exists within the image frame of the reference frame, and supplies the determination result thereof to the second order prediction unit 76.

By comparing the second order residuals from the second order prediction unit 76, the motion prediction/compensation unit 75 can determine an optimal intra prediction mode for second order prediction. Also, by comparing second order residual and first order residual, the motion prediction/compensation unit 75 determines whether or not to perform second order prediction processing (i.e., whether to encode second order residual or to encode first order residual). Note that these processing are performed on all candidate inter prediction modes.

Also, the motion prediction/compensation unit 75 calculates a cost function value as to all of the inter prediction modes serving as candidates. At this time, the motion prediction/compensation unit 75 calculates a cost function value using, of the first order residual and second order residual, the residual determined for each inter prediction mode. The motion prediction/compensation unit 75 determines, of the calculated cost function values, the prediction mode that provides the minimum value to be the optimal inter prediction mode.

The motion prediction/compensation unit 75 supplies the prediction image generated in the optimal inter prediction mode (or the difference between the image to be subjected to inter and the second order residual), and the cost function value thereof to the prediction image selecting unit 78. In the event that the prediction image generated in the optimal inter prediction mode by the prediction image selecting unit 78 has been selected, the motion prediction/compensation unit 75 outputs information indicating the optimal inter prediction mode to the lossless encoding unit 66.

At this time, the motion vector information, reference frame information, second order prediction flag indicating that second order prediction is to be performed, information of intra prediction mode for second order prediction, and so forth, are also output to the lossless encoding unit 66. The lossless encoding unit 66 also subjects the information from the motion prediction/compensation unit 75 to lossless encoding processing such as variable length coding, arithmetic coding, or the like, and inserts into the header portion of the compressed image.

The prediction image selecting unit 78 determines the optimal prediction mode from the optimal intra prediction mode and the optimal inter prediction mode based on the cost function values output from the intra prediction unit 74 or motion prediction/compensation unit 75. The prediction image selecting unit 78 then selects the prediction image in the determined optimal prediction mode, and supplies to the computing units 63 and 70. At this time, the prediction image selecting unit 78 supplies the selection information of the prediction image to the intra prediction unit 74 or motion prediction/compensation unit 75.

The rate control unit 79 controls the rate of the quantization operation of the quantization unit 65 based on a compressed image stored in the storing buffer 67 so as not to cause overflow or underflow.

### [Description of H.264/AVC Format]

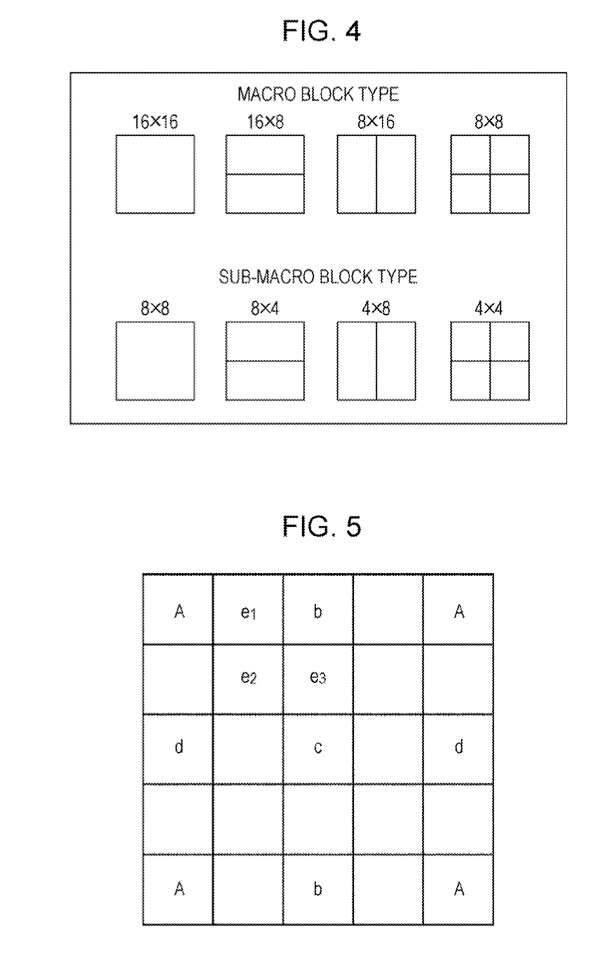

FIG. 4 is a diagram illustrating an example of the block size of motion prediction and compensation according to the H.264/AVC format. With the H.264/AVC format, motion prediction and compensation is performed with the block size being variable.

Macro blocks made up of 16×16 pixels divided into 16×16-pixel, 16×8-pixel, 8×16-pixel, and 8×8-pixel partitions are shown from the left in order on the upper tier in FIG. 4. 8×8-pixel partitions divided into 8×8-pixel, 8×4-pixel, 4×8-pixel, and 4×4-pixel sub partitions are shown from the left in order on the lower tier in FIG. 4.

Specifically, with the H.264/AVC format, one macro block may be divided into one of 16×16-pixel, 16×8-pixel, 8×16-pixel, and 8×8-pixel partitions with each partition having independent motion vector information. Also, an 8×8-pixel partition may be divided into one of 8×8-pixel, 8×4-pixel, 4×8-pixel, and 4×4-pixel sub partitions with each sub partition having independent motion vector information.

FIG. 5 is a diagram for describing prediction and compensation processing with ¼ pixel precision according to the H.264/AVC format. With the H.264/AVC format, prediction and compensation processing with ¼ pixel precision using 6-tap FIR (Finite Impulse Response Filter) filter is performed.

With the example in FIG. 5, positions A indicate the positions of integer precision pixels, and positions b, c, and d indicate positions with ½ pixel precision, and positions e1, e2, and e3 indicate positions with ¼ pixel precision. First, hereafter, Clip( ) is defined as with the following Expression (1).

$$\begin{matrix}[ Mathematical Expression 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

Note that, in the event that the input image has 8-bit precision, the value of max_pix becomes 255.

The pixel values in the positions b and d are generated as with the following Expression (2), using a 6-tap FIR filter.

[Mathematical Expression 2]

F=A₋₂−5·A₋₁+20·A₀+20·A₁−5·A₂+A₃

b,d=Clip1((F+16)≧≧5) (2)

The pixel value in the position c is generated as with the following Expression (3) by applying a 6-tap FIR filter in the horizontal direction and the vertical direction.

[Mathematical Expression 3]

F=b₋₂−5·b₋₁+20·b₀+20·b₁−5·b₂+b₃

or

F=d₋₁−5·d₋₁+20·d₀+20·d₁−5·d₂+d₃

c=Clip1((F+512)>>10) (3)

Note that Clip processing is lastly executed only once after both of sum-of-products processing in the horizontal direction and the vertical direction are performed.

Positions e1 through e3 are generated by linear interpolation as shown in the following Expression (4).

[Mathematical Expression 4]

e₁=(A+b+1)>>1

e₂=(b+d+1)>>1

e₃=(b+c+1)>>1 (4)

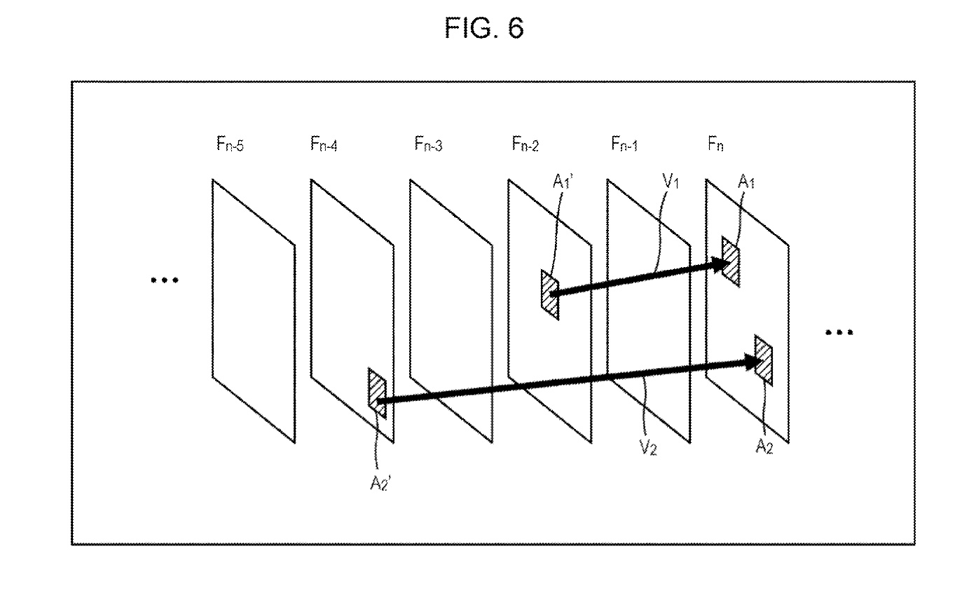

FIG. 6 is a diagram for describing the prediction and compensation processing of multi-reference frames according to the H.264/AVC format. With the H.264/AVC format, the motion prediction and compensation method of multi-reference frames (Multi-Reference Frame) is set.

With the example in FIG. 6, the current frame Fn to be encoded from now on, and encoded frames Fn-5 through Fn-1 are shown. The frame Fn-1 is, on the temporal axis, a frame one frame ahead of the current frame Fn, the frame Fn-2 is a frame two frames ahead of the current frame Fn, and the frame Fn-3 is a frame three frames ahead of the current frame Fn. Similarly, the frame Fn-4 is a frame four frames ahead of the current frame Fn, and the frame Fn-5 is a frame five frames ahead of the current frame Fn. In general, the closer to the current frame Fn a frame is on the temporal axis, the smaller a reference picture number (ref_id) to be added is. Specifically, the frame Fn-1 has the smallest reference picture number, and hereafter, the reference picture numbers are small in the order of Fn-2, . . . , Fn-5.

With the current frame Fn, a block A1 and a block A2 are shown, a motion vector V1 is searched with assuming that the block A1 is correlated with a block A1′ of the frame Fn-2 that is two frames ahead of the current frame Fn. Similarly, a motion vector V2 is searched with assuming that the block A2 is correlated with a block A1′ of the frame Fn-4 that is four frames ahead of the current frame Fn.

As described above, with the H.264/AVC format, different reference frames may be referenced in one frame (picture) with multi-reference frames stored in memory. Specifically, for example, such that the block A1 references the frame Fn-2, and the block A2 reference the frame Fn-4, independent reference frame information (reference picture number (ref_id)) may be provided for each block in one picture.

Here, the blocks indicate one of 16×16-pixel, 16×8-pixel, 8×16-pixel, and 8×8-pixel partitions described with reference to FIG. 4. Reference frames within an 8×8-pixel sub-block partition have to agree.

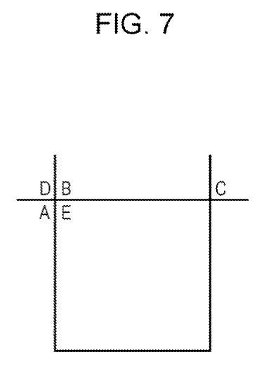

With the H.264/AVC format, by the motion prediction and compensation processing described above with reference to FIGS. 4 through 6 being performed, vast amounts of motion vector information are generated, and if these are encoded without change, deterioration in encoding efficiency is caused. In response to this, with the H.264/AVC format, according to a method shown in FIG. 7, reduction in motion vector coding information has been realized.

FIG. 7 is a diagram for describing a motion vector information generating method according to the H.264/AVC format.

With the example in FIG. 7, a current block E to be encoded from now (e.g., 16×16 pixels), and blocks A through D, which have already been encoded, adjacent to the current block E are shown.

Specifically, the block D is adjacent to the upper left of the current block E, the block B is adjacent to above the current block E, the block C is adjacent to the upper right of the current block E, and the block A is adjacent to the left of the current block E. Note that the reason why the blocks A through D are not sectioned is because each of the blocks represents a block having one structure of 16×16 pixels through 4×4 pixels described above with reference to FIG. 3.

For example, let us say that motion vector information as to X (=A, B, C, D, E) is represented with mv_{X}. First, prediction motion vector information pmv_{E} as to the current block E is generated as with the following Expression (5) by median prediction using motion vector information regarding the blocks A, B, and C.

pmv_{E}=med(mv_{A},mv_{B},mv_{C}) (5)

The motion vector information regarding the block C may not be used (may be unavailable) due to a reason such as the edge of an image frame, before encoding, or the like. In this case, the motion vector information regarding the block D is used instead of the motion vector information regarding the block C.

Data mvd_{E} to be added to the header portion of the compressed image, serving as the motion vector information as to the current block E, is generated as in the following Expression (6) using pmv_{E}.

mvd_{E}=mv_{E}−pmv_{E} (6)

Note that, in reality, processing is independently performed as to the components in the horizontal direction and vertical direction of the motion vector information.

In this way, prediction motion vector information is generated, data mvd_{E} that is difference between the prediction motion vector information generated based on correlation with an adjacent block and the motion vector information is added to the header portion of the compressed image, whereby the motion vector information can be reduced.

### [Configuration Example of Second Order Prediction Unit]

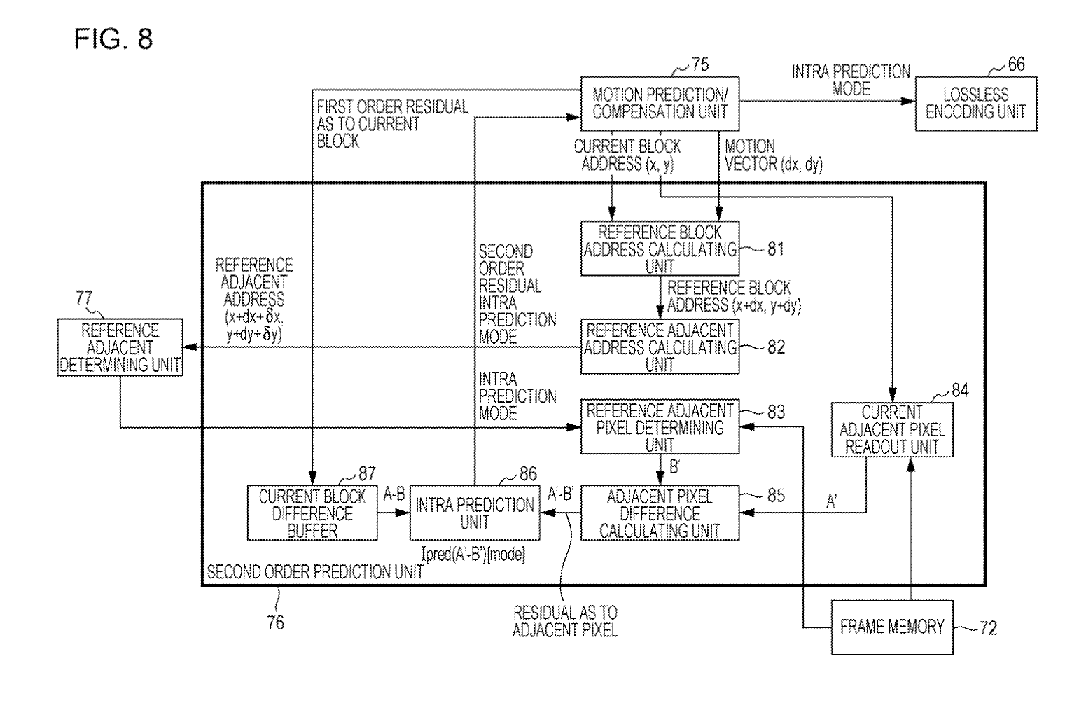

FIG. 8 is a block diagram illustrating a detailed configuration example of the second order prediction unit.

In the example in FIG. 8, the second order prediction unit 76 is configured of a reference block address calculating unit 81, a reference adjacent address calculating unit 82, a reference adjacent pixel determining unit 83, a current adjacent pixel readout unit 84, an adjacent pixel difference calculating unit 85, an intra prediction unit 86, and a current block difference buffer 87.

The motion prediction/compensation unit 75 supplies a motion vector (dx, dy) as to a current block, to the reference block address calculating unit 81. The motion vector prediction/compensation unit 75 supplies a current block address (x, y) to the reference block address calculating unit 81 and the current adjacent pixel readout unit 84. The motion vector prediction/compensation unit 75 supplies a first order residual which is difference between the current block and a reference block (prediction image) to the current block difference buffer 87.

The reference block address calculating unit 81 determines a reference block address (x+dx, y+dy) from the current block address (x, y) and the motion vector (dx, dy) as to the current block from the motion vector prediction/compensation unit 75. The reference block address calculating unit 81 supplies the determined reference block address (x+dx, y+dy) to the reference adjacent address calculating unit 82.

The reference adjacent address calculating unit 82 calculates a reference adjacent address which is the relative address of the reference adjacent pixel, based on the reference block address (x+dx, y+dy) and the relative address of the current adjacent pixel adjacent to the current block. The reference adjacent address calculating unit 82 supplies the calculated reference adjacent address (x+dx+δx, y+dy+δy) to the reference adjacent determining unit 77.

Determination results of whether or not the reference adjacent pixel exists within the image frame of the reference frame are input from the reference adjacent determining unit 77 to the reference adjacent pixel determining unit 83. In the event that the adjacent pixel exists within the image frame of the reference frame, the reference adjacent pixel determining unit 83 reads out the adjacent pixel defined in H.264/AVC from the frame memory 72, and stores this in an unshown built-in buffer.

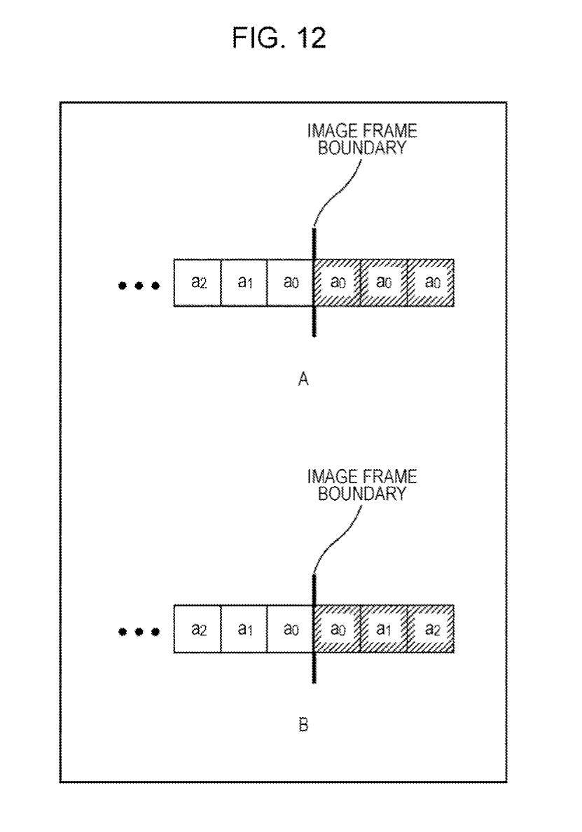

On the other hand, in the event that the reference adjacent pixel does not exist within the image frame of the reference frame, the reference adjacent pixel determining unit 83 performs terminal point processing regarding the nonexistent adjacent pixel to determine the pixel value of the reference adjacent pixel, which is read out from the frame memory 72, and stored in the unshown built-in buffer. Now, terminal point processing is processing for taking another pixel value existing within the image frame of the reference frame as the pixel value of the adjacent pixel which does not exist within the image frame, for example, and will be described later in detail with reference to FIG. 12.

The current adjacent pixel readout unit 84 uses the reference block address (x, y) from the motion prediction/compensation unit 75 to read out the pixel value of the current block from the frame memory 72, stores this in an unshown built-in buffer.

The adjacent pixel difference calculating unit 85 reads out a current adjacent pixel [A′] from the built-in buffer built into the current adjacent pixel readout unit 84, and also reads out a reference adjacent pixel [B′] corresponding to the current adjacent pixel from the built-in buffer built into the adjacent pixel difference calculating unit 85. The adjacent pixel difference calculating unit 85 then calculates the difference between the current adjacent pixel [A′] and reference adjacent pixel [B′] read out from the respective built-in buffers, and stores this as a residual [A′−B′] as to the adjacent pixel in an unshown built-in buffer.

The intra prediction unit 86 reads out the residual [A′−B′] as to the adjacent pixel from the built-in buffer of the adjacent pixel difference calculating unit 85, and reads out a first order residual [A−B] as to the current block from the current block difference buffer 87. The intra prediction unit 86 uses the residual [A′−B′] as to the adjacent pixel to perform intra prediction regarding the current block in each intra prediction mode [mode], and generates an intra prediction image Ipred(A′−B′)[mode].

The intra prediction unit 86 then generates a second order residual which is the difference between the first order residual as to the current block and the intra prediction image predicted regarding the current block, and supplies the generated second order residual and information of the intra prediction mode at that time to the motion prediction/compensation unit 75.

Note that a circuit for performing intra prediction as second order prediction at the intra prediction unit 86 in the example in FIG. 8 can share a circuit with the intra prediction unit 75.

### [Description of Operations of Second Order Prediction Unit and Reference Adjacent Determining Unit]

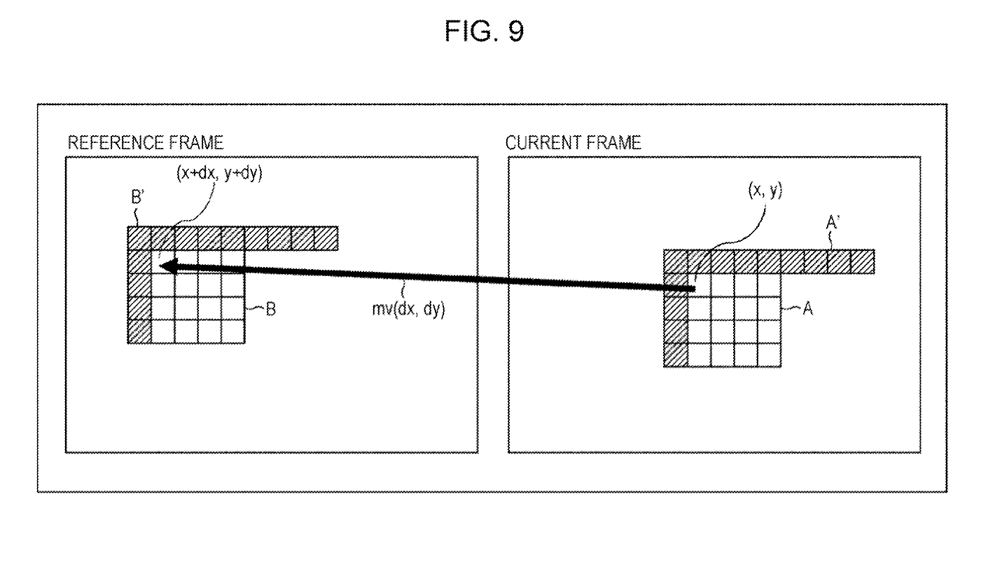

Next, the operations of the second order prediction unit 76 and reference adjacent determining unit 77 will be described with reference to FIG. 9. Note that the following description will be made regarding a case where the block size of a current block is 4×4 pixels.

With the example in FIG. 9, a current frame and reference frame are shown, with a current block A and current adjacent pixels A′ adjacent to the current block A being shown in the current frame. Also, a motion vector mv(dx, dy) obtained at the reference frame with regard to the current frame A being shown between the current frame and reference frame.

Further, in the reference frame are shown a reference block B correlated to the current block A by the motion vector mv(dx, dy), and reference adjacent pixels B′ adjacent to the reference block B. Note that in the drawings, the current adjacent pixels A′ and reference adjacent pixels B′ are shown hatched, to distinguish from the pixels of the current block A and reference block B.

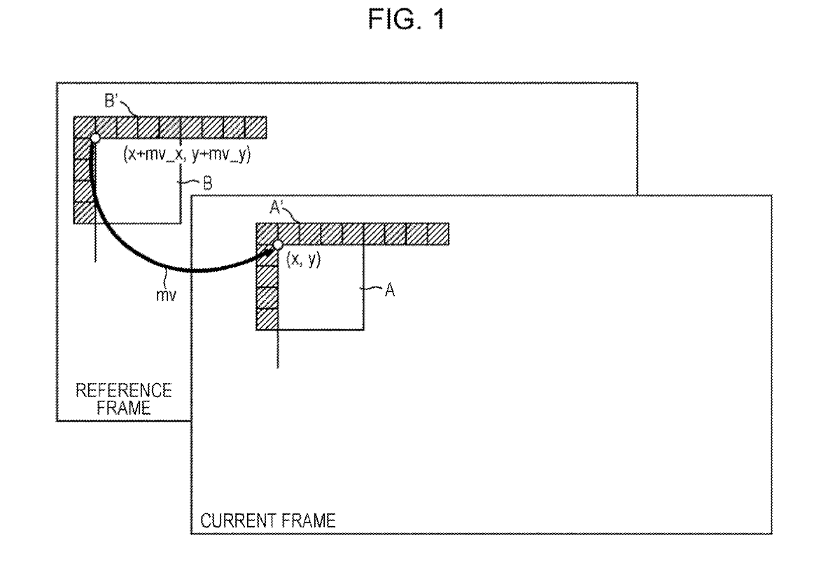

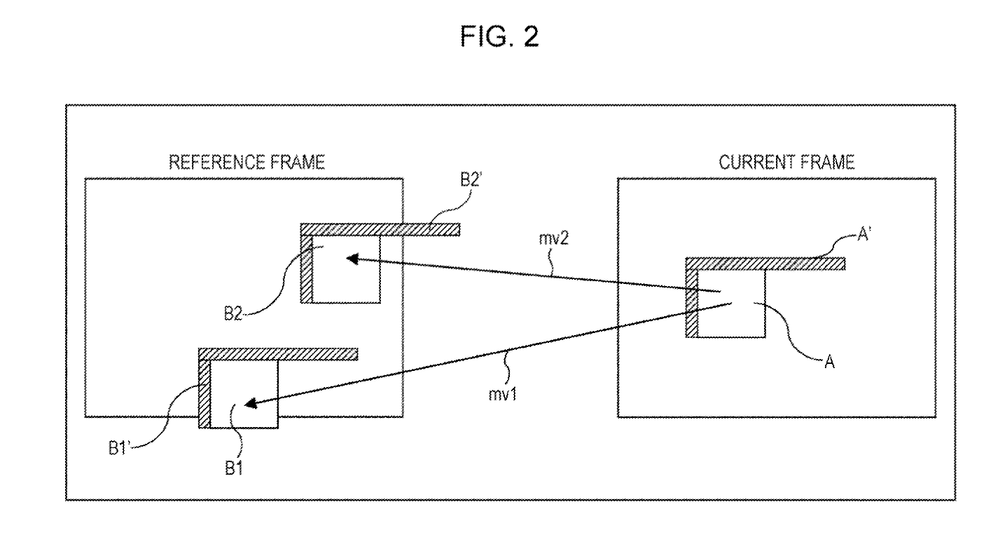

First, at the second order prediction unit 76, the second order prediction processing described above with reference to FIG. 1 is performed. At this time, determination is made by the reference adjacent determining unit 77 whether or not the reference adjacent pixels B′ as to the reference block B exist within the image frame, and settings are made at the second order prediction unit 76 as follows.

That is to say, as shown in FIG. 9, if we define the address (coordinates) of the pixel situated at the upper left of the current block A as (x, y), the address of the pixel situated at the upper left of the reference block B is defined as (x+dx, y+dy) due to the motion vector mv(dx, dy).

At this time, the addresses of the current adjacent pixels A′ are defined as (x+δx, y+δy), and the addresses of the current adjacent pixels B′ are defined as (x+dx+δx, y+dy+δy), by way of the following Expression (7).

(δx,δy)={(−1,−1),(0,−1),(1,−1),(2,−1),(3,−1),(4,−1),(5,−1),(6,−1),(7,−1),(−1,0),(−1,1),(−1,2),(−1,3)} (7)

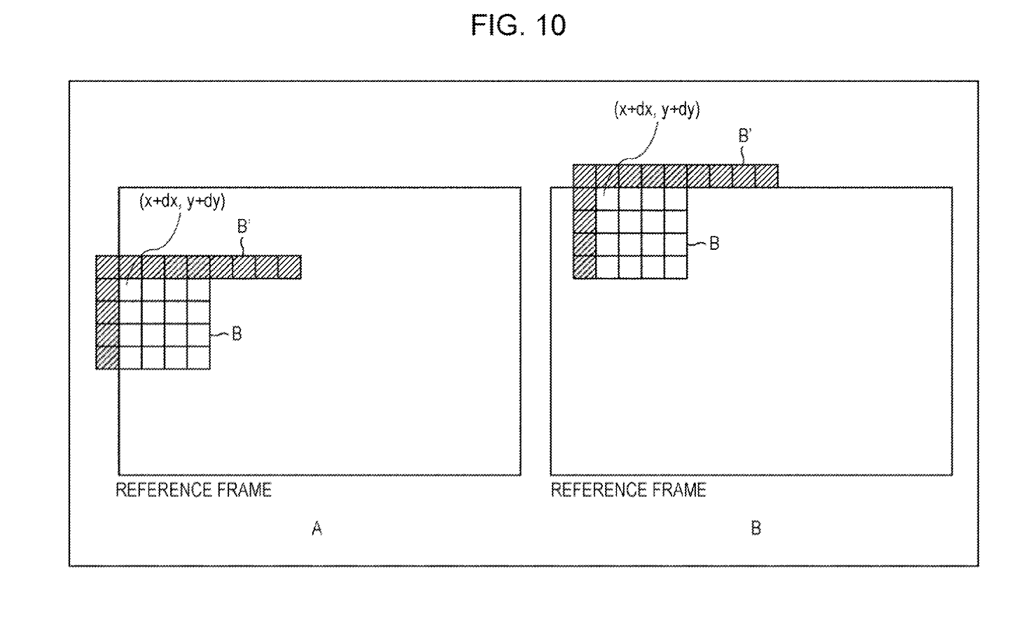

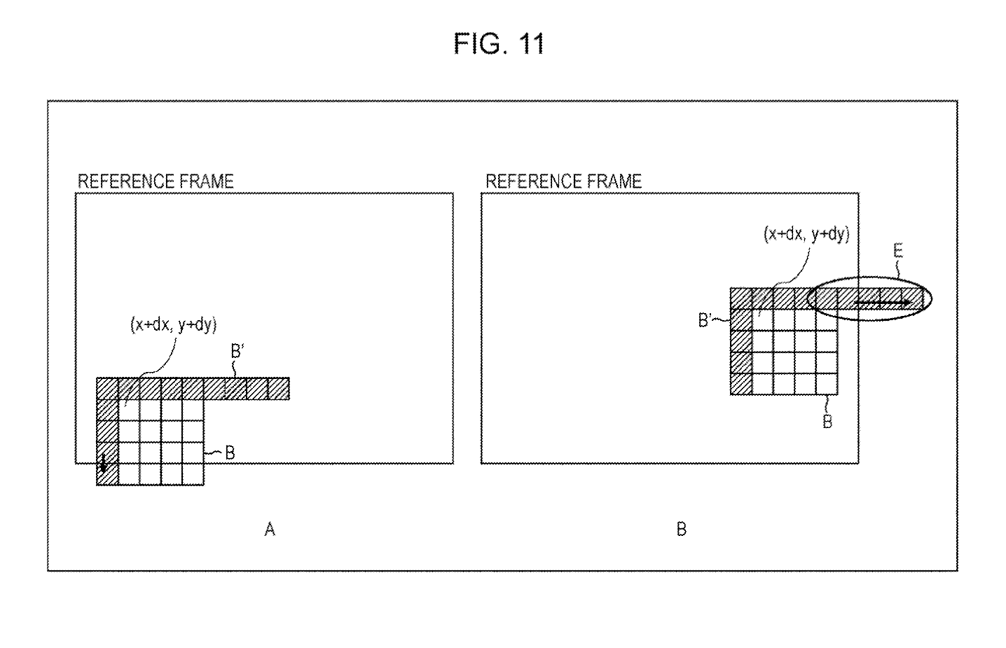

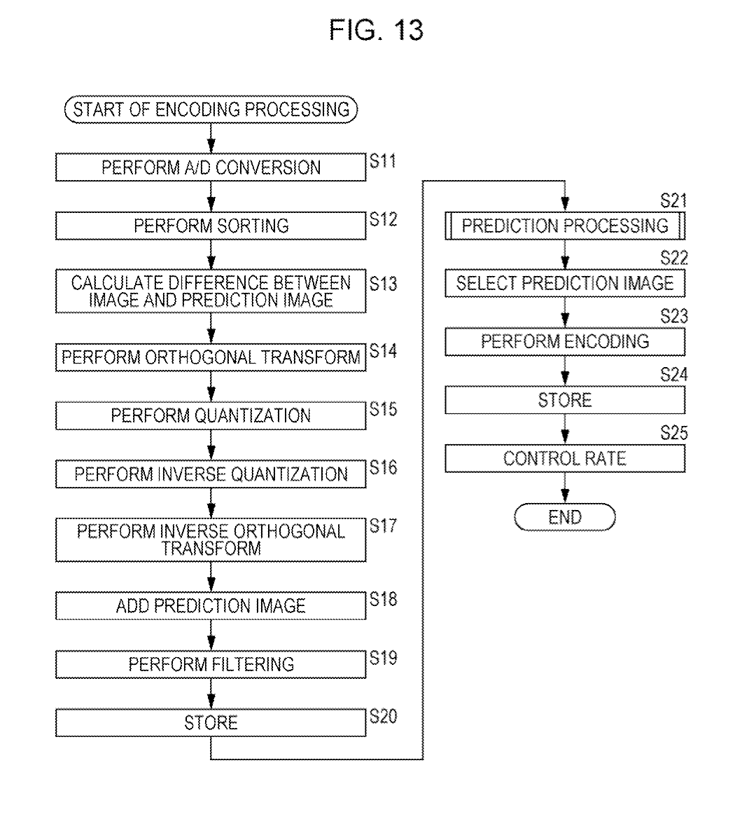

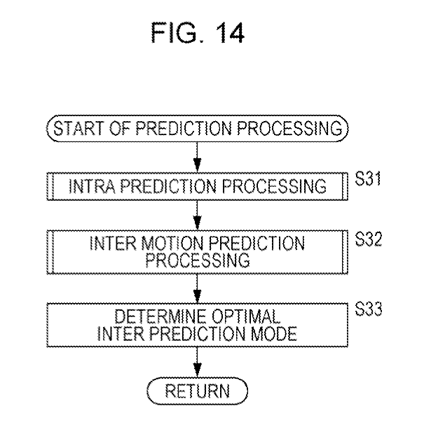

Next, setting of the reference adjacent pixels B′ as to the reference block B using these addresses, will be described with reference to FIG. 10 and FIG. 11. Note that the definition of the current adjacent pixels A′ as to the current block A conforms to the definitions of H.264/AVC. That is to say, the details thereof will be described later with reference to FIG. 13 and FIG. 14.

First, in the example of A in FIG. 10, an example is shown in which a part of the reference adjacent pixels B′ adjacent to the reference block B protrudes outside from the left side of the image frame of the reference frame. In the example of B in FIG. 10, an example is shown in which a part of the reference adjacent pixels B′ adjacent to the reference block B protrudes outside from the upper side of the image frame of the reference frame.

In these cases, i.e., with regard to reference adjacent pixels B′ where the following Expression (8) holds, the second order prediction unit 76 sets the pixel values to 2ⁿ⁻¹. Here, we will say that the pixel values are represented as n bits, and in the event of 8 bits, the pixel value is 128.

x+dx+δx<0 or y+dy+δy>0 (8)

Next, in the example of A in FIG. 11, an example is shown in which a part of the reference adjacent pixels B′ as well as a part of the reference block B protrude outside from the bottom side of the image frame of the reference frame. In the example of B in FIG. 11, an example is shown in which apart of the reference adjacent pixels B′ adjacent to the reference block B protrudes outside from the right side of the image frame of the reference frame.

Now, we will say that the image frame size of the current frame and reference frame is WIDTH×HEIGHT. In the event that the image frame size is WIDTH×HEIGHT, in a case such as shown in A in FIG. 11, i.e., with regard to reference adjacent pixels B′ where the following Expression (9) holds, the second order prediction unit 76 sets a pixel pointed to by the address (WIDTH−1, y+dy+δy) as a reference adjacent pixel.

x+dx+δx>WIDTH−1 (9)

Also, in the event that the image frame size is WIDTH×HEIGHT, in a case such as shown in B in FIG. 11, i.e., where the following Expression (10) holds, the second order prediction unit 76 sets a pixel pointed to by the address (x+dx+δx, HEIGHT−1) as a reference adjacent pixel.

y+dy+δy>HEIGHT−1 (10)

Further, in the event that the image frame size is WIDTH×HEIGHT, in a case where both Expressions (9) and (10) hold, the second order prediction unit 76 sets a pixel pointed to by the address (WIDTH−1, HEIGHT−1) as a reference, adjacent pixel.

That is to say, regarding reference adjacent pixels protruding out from the image frame as indicated by the arrows in A in FIG. 11 and B in FIG. 11, the processing of the second order prediction unit 76 setting reference adjacent pixels is nothing else than using the same value as that of the reference adjacent pixel existing within the image frame, which is one type of terminal point processing. This processing is called hold processing. Note that mirror processing, which is another type of terminal point processing, may be applied instead of this hold processing.

Next, hold processing and mirror processing which are terminal point processing will be described with reference to FIG. 12. Note that the range of E shown in B in FIG. 11 is shown enlarged in the example of A in FIG. 12 as an example of hold processing, and in the example of B in FIG. 12 as an example of mirror processing.

The reference adjacent pixels to the left side in the drawing from the image frame boundary exist within the image frame, and have pixel values of a0, a1, and a2 in order from the image frame boundary side, for example. However, the reference adjacent pixels to the right side in the drawing from the image frame boundary exist outside of the image frame.

Accordingly, with the hold processing shown in A in FIG. 12, the pixel values of the reference adjacent pixels outside of the image frame are virtually generated using the pixel value a0 of the reference adjacent pixel that is closest to the image frame boundary within the image frame.

Also, with the mirror processing shown in B in FIG. 12, processing is performed as if virtual pixel values exist as a mirror image with the image frame boundary as the center.

That is to say, with mirror processing, the pixel value of the reference adjacent pixel closest to the image frame boundary side outside of the image frame is virtually generated using the pixel value a0 of the reference adjacent pixel closest to the image frame boundary inside the image frame. The pixel value of the reference adjacent pixel second closest to the image frame boundary side outside of the image frame is virtually generated using the pixel value a1 of the reference adjacent pixel second closest to the image frame boundary inside the image frame. The pixel value of the reference adjacent pixel third closest to the image frame boundary side outside of the image frame is virtually generated using the pixel value a2 of the reference adjacent pixel third closest to the image frame boundary inside the image frame.

Note that in the above description, description has been made by way of an example of intra 4×4 prediction, but in the case of intra 8×8 prediction, the same processing can be performed by defining as in the following Expression (11) instead of the above-described Expression (7).

(δx,δy)={(−1,−1),(0,−1),(1,−1),(2,−1),(3,−1),(4,−1),(5,−1),(6,−1),(7,−1),(8,−1),(9,−1),(10,−1),(11,−1),(12,−1),(13,−1),(14,−1),(15,−1),(−1,0),(−1,1),(−1,2),(−1,3),(−1,4),(−1,5),(−1,6),(−1,7)} (11)

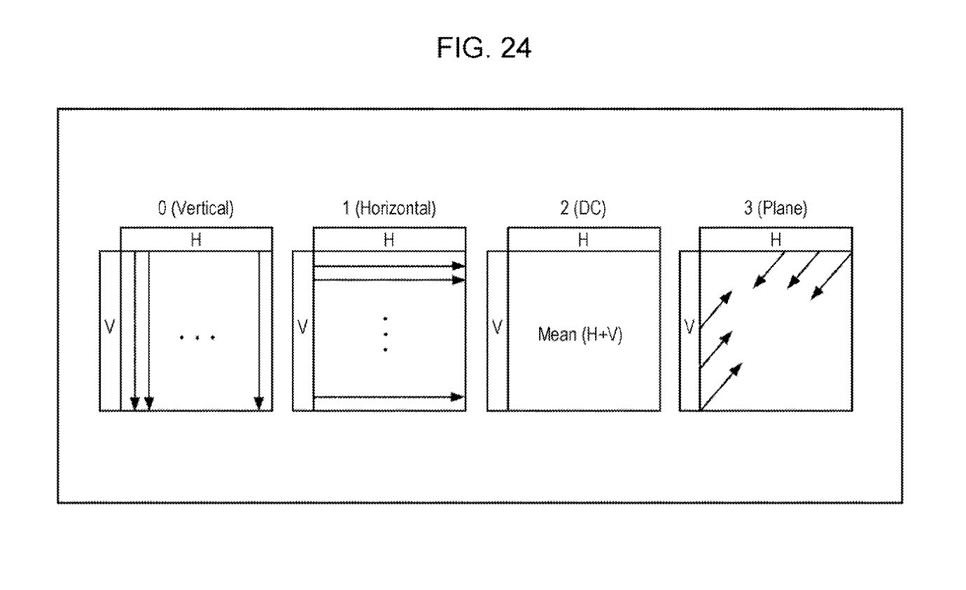

In the case of intra 16×16 prediction, of the adjacent pixels, the pixel values of adjacent pixels situated to the upper right of the block are not used for intra prediction, as shown in FIG. 24 which will be described later. Accordingly, the same processing can be performed by defining as in the following Expression (12) instead of the above-described Expression (7).

(δx,δy)={(−1,−1),(0,−1),(1,−1),(2,−1),(3,−1),(4,−1),(5,−1),(6,−1),(7,−1),(8,−1),(9,−1),(10,−1),(11,−1),(12,−1),(13,−1),(14,−1),(15,−1),(−1,0),(−1,1),(−1,2),(−1,3),(−1,4),(−1,5),(−1,6),(−1,7),(−1,8),(−1,9),(−1,10),(−1,11),(−1,12),(−1,13),(−1,14),(−1,15)} (12)

With color difference signals as well, in the same way as with the case of intra 16×16 prediction, of the adjacent pixels, the pixel values of adjacent pixels situated to the upper right of the block are not used for intra prediction. Accordingly, the same processing can be performed by defining as in the following Expression (13) instead of the above-described Expression (7).

(δx,δy)={(−1,−1),(0,−1),(1,−1),(2,−1),(3,−1),(4,−1),(5,−1),(6,−1),(7,−1),(−1,0),(−1,1),(−1,2),(−1,3),(−1,4),(−1,5),(−1,6),(−1,7)} (13)

As described above, with the image encoding device 51, determination is made regarding whether or not a reference adjacent pixel exists outside the image frame, and in the event that a reference adjacent pixel exists outside the image frame, hold or mirror terminal point processing is performed as to that pixel.

Accordingly, second order prediction processing can be performed even in cases wherein reference adjacent pixels exist outside the image frame, and consequently encoding efficiency can be improved.

### [Description of Encoding Processing of Image Encoding Device]

Next, the encoding processing of the image encoding device 51 in FIG. 3 will be described with reference to the flowchart in FIG. 13.

In step S11, the A/D converter 61 performs A/D conversion of an input image. In step S12, the screen sorting buffer 62 stores the image supplied from the A/D converter 61, and performs sorting of the pictures from the display order to the encoding order.

In step S13, the computing unit 63 computes the difference between the image sorted in step S12 and a prediction image. The prediction image is supplied from the motion prediction/compensation unit 75 in the case of performing inter prediction, and from the intra prediction unit 74 in the case of performing intra prediction, to the computing unit 63 via the prediction image selecting unit 78.

The amount of data of the difference data is smaller in comparison to that of the original image data. Accordingly, the data amount can be compressed as compared to a case of performing encoding of the image as it is.

In step S14, the orthogonal transform unit 64 performs orthogonal transform of the difference information supplied from the computing unit 63. Specifically, orthogonal transform such as disperse cosine transform, Karhunen-Loève transform, or the like, is performed, and transform coefficients are output. In step S15, the quantization unit 65 performs quantization of the transform coefficients. The rate is controlled for this quantization, as described with the processing in step S25 described later.

The difference information quantized as described above is locally decoded as follows. That is to say, in step S16, the inverse quantization unit 68 performs inverse quantization of the transform coefficients quantized by the quantization unit 65, with properties corresponding to the properties of the quantization unit 65. In step S17, the inverse orthogonal transform unit 69 performs inverse orthogonal transform of the transform coefficients subjected to inverse quantization at the inverse quantization unit 68, with properties corresponding to the properties of the orthogonal transform unit 64.

In step S18, the computing unit 70 adds the prediction image input via the prediction image selecting unit 78 to the locally decoded difference information, and generates a locally decoded image (image corresponding to the input to the computing unit 63). In step S19, the deblocking filter 71 performs filtering of the image output from the computing unit 70. Accordingly, block noise is removed. In step S20, the frame memory 72 stores the filtered image. Note that the image not subjected to filter processing by the deblocking filter 71 is also supplied to the frame memory 72 from the computing unit 70, and stored.

In step S21, the intra prediction unit 74 and motion prediction/compensation unit 75 perform their respective image prediction processing. That is to say, in step S21, the intra prediction unit 74 performs intra prediction processing in the intra prediction mode, and the motion prediction/compensation unit 75 performs motion prediction/compensation processing in the inter prediction mode.

At this time, the reference adjacent determining unit 77 determines whether or not adjacent pixels adjacent to the reference block exist within the image frame of the reference frame, the second order prediction unit 76 performs terminal point processing on the reference adjacent pixels in accordance with the determination results thereof, following which second order prediction is performed and second order residual is generated. The motion prediction/compensation unit 75 determines, of the first order residual and second order residual, which residual has better encoding efficiency.

Note that in the event that second order prediction is performed, there is the need to send to the decoding side a second order prediction flag indicating that second order prediction will be performed, and information indicating the intra prediction mode for the second order prediction. These information are supplied to the lossless encoding unit 66 along with optimal inter prediction mode information and so forth, in the event that a prediction image of an optimal inter prediction mode is selected in step S22 described later.

While the details of the prediction processing in step S21 will be described later in detail with reference to FIG. 14, with this processing, prediction processing is performed in each of all candidate intra prediction modes, and cost function values are each calculated in all candidate intra prediction modes. An optimal intra prediction mode is selected based on the calculated cost function value, and the prediction image generated by the intra prediction in the optimal intra prediction mode and the cost function value are supplied to the prediction image selecting unit 78.

Also, with this processing, prediction processing in all candidate inter prediction modes is performed, and cost function values in all candidate inter prediction modes are each calculated using the determined residual. An optimal inter prediction mode is determined from the inter prediction modes based on the calculated cost function value, and the prediction image generated with the optimal inter prediction mode and the cost function value thereof are supplied to the prediction image selecting unit 78. Note that in the event that second order prediction is performed regarding the optimal inter prediction mode, the difference between the image to be subjected to be inter processing and the second order residual is supplied to the prediction image selecting unit 78 as a prediction image.

In step S22, the prediction image selecting unit 78 determines one of the optimal intra prediction mode and optimal inter prediction mode as the optimal prediction mode, based on the respective cost function values output from the intra prediction unit 74 and the motion prediction/compensation unit 75. The prediction image selecting unit 78 then selects the prediction image of the determined optimal prediction mode, and supplies this to the computing units 63 and 70. The prediction image (in the case that second order prediction is performed, the difference between the image to be subjected to be inter processing and the second order residual) is used for computation in steps S13 and S18, as described above.

Note that the selection information of the prediction image is supplied to the intra prediction unit 74 or motion prediction/compensation unit 75. In the event that the prediction image of the optimal intra prediction mode is selected, the intra prediction unit 74 supplies information relating to the optimal intra prediction mode (i.e., intra prediction mode information) to the lossless encoding unit 66.

In the event that the prediction image of the optimal inter prediction mode is selected, the motion prediction/compensation unit 75 outputs information relating to the optimal inter prediction mode, and information corresponding to the optimal inter prediction mode as necessary, to the lossless encoding unit 66. Examples of information corresponding to the optimal inter prediction mode include a second order prediction flag indicating that second order prediction is to be performed, information indicating the intra prediction mode in second order prediction, reference frame information, and so forth.

In step S23, the lossless encoding unit 66 encodes the quantized transform coefficients output from the quantization unit 65. That is to say, the difference image (second order difference image in the case of second order prediction) is subjected to lossless encoding such as variable-length encoding, arithmetic encoding, or the like, and compressed. At, this time, the information relating to the optimal intra prediction mode from the intra prediction unit 74 input to the lossless encoding unit 66 in step S22 described above, or the information according to the optimal inter prediction mode from the motion prediction/compensation unit 75 and so forth, also is encoded and added to the header information.

In step S24, the storage buffer 67 stores the difference image as a compressed image. The compressed image stored in the storage buffer 67 is read out as appropriate, and transmitted to the decoding side via the transmission path.

In step S25, the rate control unit 79 controls the rate of quantization operations of the quantization unit 65 so that overflow or underflow does not occur, based on the compressed images stored in the storage buffer 67.

### [Description of Prediction Processing]

Next, the prediction processing in step S21 of FIG. 13 will be described with reference to the flowchart in FIG. 14.

In the event that the image to be processed that is supplied from the screen sorting buffer 62 is a block image for intra processing, a decoded image to be referenced is read out from the frame memory 72, and supplied to the intra prediction unit 74 via the switch 73. Based on these images, in step S31 the intra prediction unit 74 performs intra prediction of pixels of the block to be processed for all candidate intra prediction modes. Note that for decoded pixels to be referenced, pixels not subjected to deblocking filtering by the deblocking filter 71 are used.

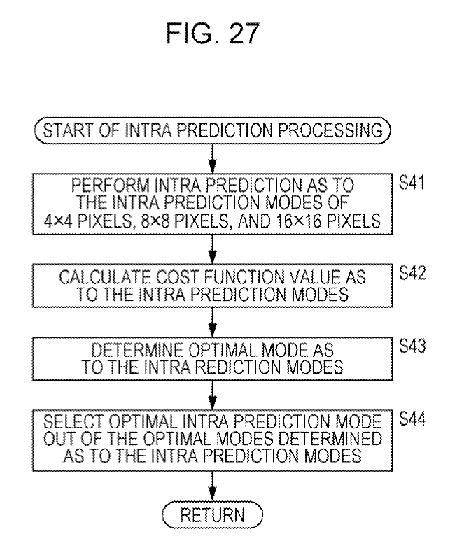

While the details of the intra prediction processing in step S31 will be described later with reference to FIG. 27, due to this processing intra prediction is performed in all candidate intra prediction modes, and cost function values are calculated for all candidate intra prediction modes. The optimal intra prediction mode is then selected based on the calculated cost function values, and the prediction image generated by intra prediction in the optimal intra prediction mode and the cost function value thereof are supplied to the prediction image selecting unit 78.

In the event that the image to be processed that is supplied from the screen sorting buffer 62 is an image for inter processing, the image to be referenced is read out from the frame memory 72, and supplied to the motion prediction/compensation unit 75 via the switch 73. In step S32, the motion prediction/compensation unit 75 performs inter motion prediction processing based on these images. That is to say, the motion prediction/compensation unit 75 perform motion prediction processing of all candidate inter prediction modes, with reference to the images supplied from the frame memory 72.

Note that at this time, the reference adjacent determining unit 77 uses the addresses of the reference adjacent pixels from the motion prediction/compensation unit 75 to determine whether or not the reference adjacent pixels exist within the image frame of the reference frame. The second order prediction unit 75 performs terminal point processing in accordance with the determination results from the reference adjacent determining unit 77, and outputs the second order residual obtained as a result of having performed second order prediction processing to the motion prediction/compensation unit 75. In response to this, the motion prediction/compensation unit 75 determines the residual of which encoding efficiency is better from the first order residual and the second order residual, and uses this for subsequent processing.

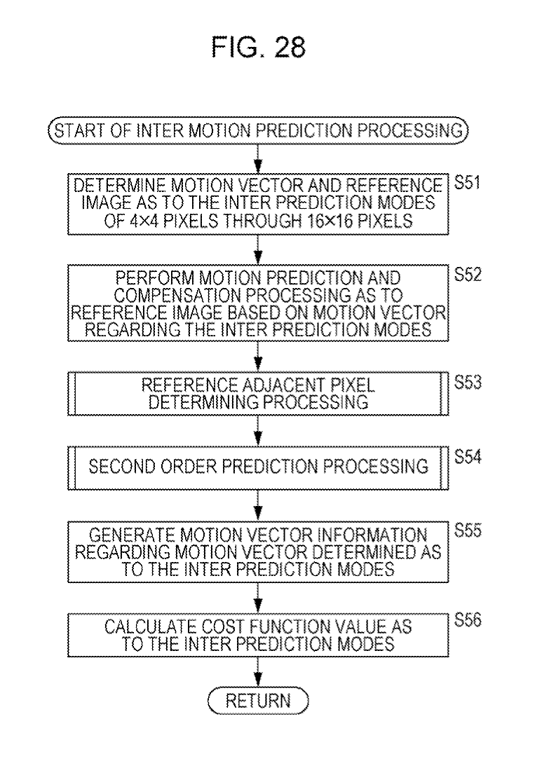

Details of the inter motion prediction processing in step S32 will be described later with reference to FIG. 28. Due to this processing, motion prediction processing is performed for all candidate inter prediction modes, and cost function values as to all candidate inter prediction modes are calculated, using first order difference or second order difference.

In step S33, the motion prediction/compensation unit 75 compares the cost function value as to the inter prediction mode calculated in step S32. The motion prediction/compensation unit 75 determines the prediction mode which gives the smallest value to be the optimal inter prediction mode, and supplies the prediction image generated in the optimal inter prediction mode and the cost function value thereof to the prediction image selecting unit 78.

### [Description of Intra Prediction Processing in H.264/AVC]

Next, the modes for intra prediction that are stipulated in the H.264/AVC format will be described.

First, the intra prediction modes as to luminance signals will be described. With the intra prediction modes for luminance signals, three formats of an intra 4×4 prediction mode, an intra 8×8 prediction mode, and an intra 16×16 prediction mode are set. These are modes for determining block units, and are set for each macro block. Also, an intra prediction mode may be set to color difference signals independently from luminance signals for each macro block.

Further, in the event of the intra 4×4 prediction mode, one prediction mode can be set out of the nine kinds of prediction modes for each 4×4-pixel current block. In the event of the intra 8×8 prediction mode, one prediction mode can be set out of the nine kinds of prediction modes for each 8×8-pixel current block. Also, in the event of the intra 16×16 prediction mode, one prediction mode can be set to a 16×16-pixel current macro block out of the four kinds of prediction modes.

Note that, hereafter, the intra 4×4 prediction mode, intra 8×8 prediction mode, and intra 16×16 prediction mode will also be referred to as 4×4-pixel intra prediction mode, 8×8-pixel intra prediction mode, and 16×16-pixel intra prediction mode as appropriate, respectively.

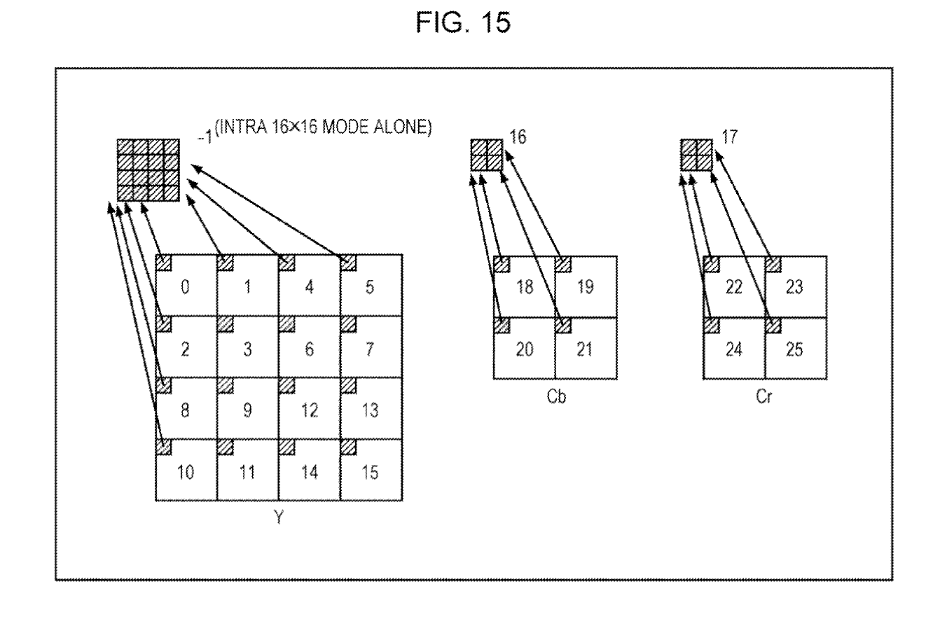

With the example in FIG. 15, numerals −1 through 25 appended to the blocks represent the bit stream sequence (processing sequence on the decoding side) of the blocks thereof. Note that, with regard to luminance signals, a macro block is divided into 4×4 pixels, and DCT of 4×4 pixels is performed. Only in the event of the intra 16×16 prediction mode, as shown in a block of −1, the DC components of the blocks are collected, a 4×4 matrix is generated, and this is further subjected to orthogonal transform.

On the other hand, with regard to color difference signals, after a macro block is divided into 4×4 pixels, and DCT of 4×4 pixels is performed, as shown in the blocks 16 and 17, the DC components of the blocks are collected, a 2×2 matrix is generated, and this is further subjected to orthogonal transform.

Note that, with regard to the intra 8×8 prediction mode, this may be applied to only a case where the current macro block is subjected to 8×8 orthogonal transform with a high profile or a profile beyond this.

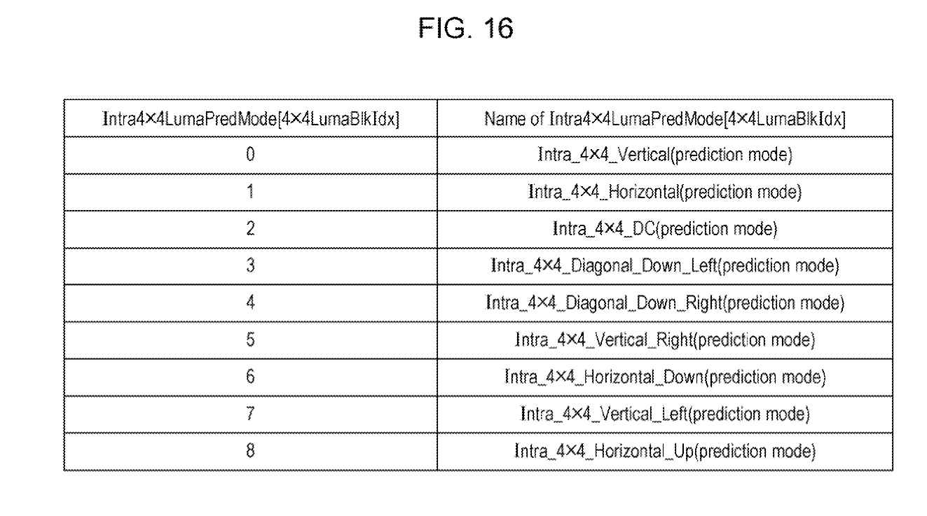

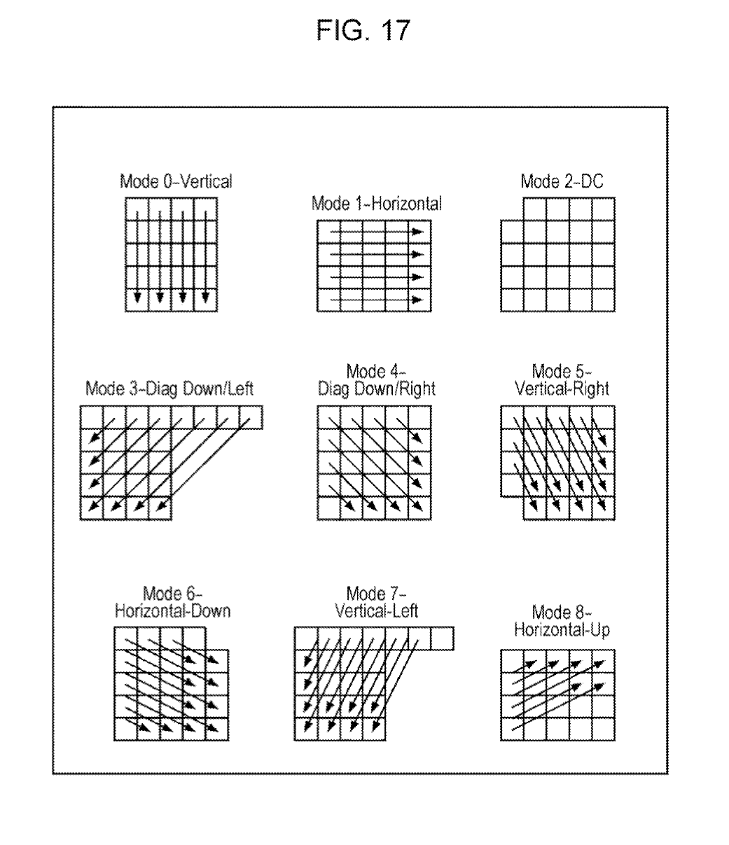

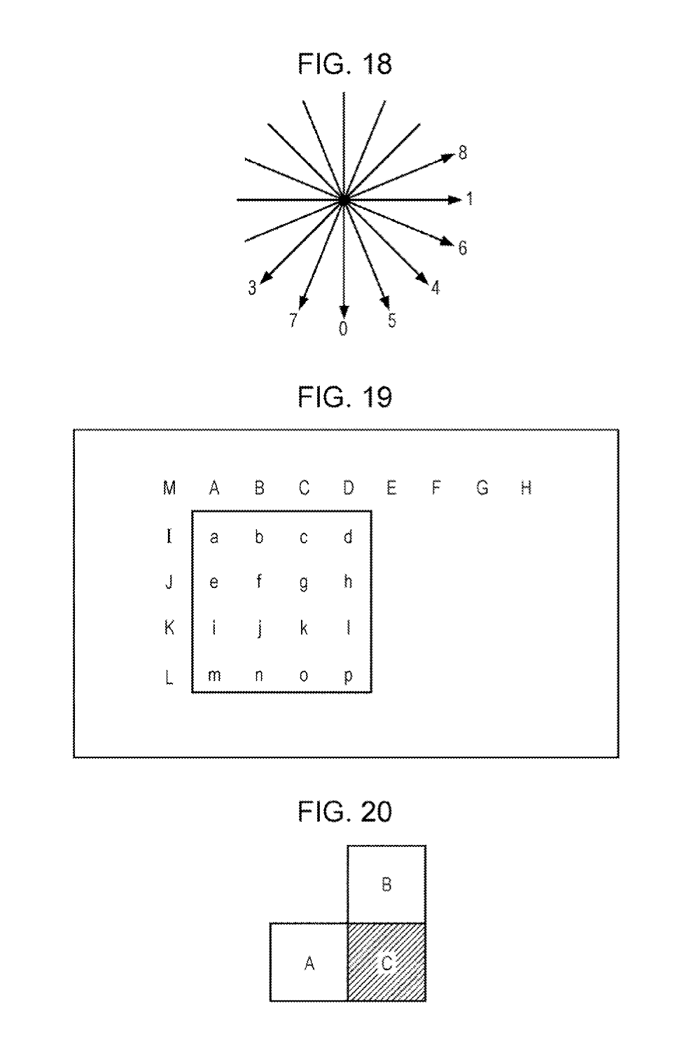

FIG. 16 and FIG. 17 are diagrams illustrating the nine types of luminance signal 4×4 pixel intra prediction modes (Intra_{—}4×4_pred_mode). The eight types of modes other than mode 2 which indicates average value (DC) prediction are each corresponding to the directions indicated by 0, 1, and 3 through 8, in FIG. 18.

The nine types of Intra_{—}4×4_pred_mode will be described with reference to FIG. 19. In the example in FIG. 19, the pixels a through p represent the pixels of the current blocks to be subjected to intra processing, and the pixel values A through M represent the pixel values of pixels belonging to adjacent blocks. That is to say, the pixels a through p are the image to be processed that has been read out from the screen sorting buffer 62, and the pixel values A through M are pixels values of the decoded image to be referenced that has been read out from the frame memory 72.

In the event of each intra prediction mode in FIG. 16 and FIG. 17, the predicted pixel values of pixels a through p are generated as follows using the pixel values A through M of pixels belonging to adjacent blocks. Note that in the event that the pixel value is “available”, this represents that the pixel is available with no reason such as being at the edge of the image frame or being still unencoded, and in the event that the pixel value is “unavailable”, this represents that the pixel is unavailable due to a reason such as being at the edge of the image frame or being still unencoded.

Mode 0 is a Vertical Prediction mode, and is applied only in the event that pixel values A through D are “available”. In this case, the prediction pixel values of pixels a through p are generated as in the following Expression (14).

Prediction pixel value of pixels a,e,i,m=A

Prediction pixel value of pixels b,f,j,n=B

Prediction pixel value of pixels c,g,k,o=C

Prediction pixel value of pixels d,h,l,p=D (14)

Mode 1 is a Horizontal Prediction mode, and is applied only in the event that pixel values I through L are “available”. In this case, the prediction pixel values of pixels a through p are generated as in the following Expression (15).

Prediction pixel value of pixels a,b,c,d=I

Prediction pixel value of pixels e,f,g,h=J

Prediction pixel value of pixels i,j,k,l=K

Prediction pixel value of pixels m,n,o,p=L (15)

Mode 2 is a DC Prediction mode, and prediction pixel values are generated as in the Expression (16) in the event that pixel values A, B, C, D, I, J, K, L are all “available”.

(A+B+C+D+I+J+K+L+4)>>3 (16)

Also, prediction pixel values are generated as in the Expression (17) in the event that pixel values A, B, C, D are all “unavailable”.

(I+J+K+L+2)>>2 (17)

Also, prediction pixel values are generated as in the Expression (18) in the event that pixel values I, J, K, L are all “unavailable”.

(A+B+C+D+2)>>2 (18)

Also, in the event that pixel values A, B, C, D, I, J, K, L are all “unavailable”, 128 is generated as a prediction pixel value.

Mode 3 is a Diagonal_Down_Left Prediction mode, and is applied only in the event that pixel values A, B, C, D, I, J, K, L, M are “available”. In this case, the prediction pixel values of the pixels a through p are generated as in the following Expression (19).

Prediction pixel value of pixel a=(A+2B+C+2)>>2

Prediction pixel values of pixels b,e=(B+2C+D+2)>>2

Prediction pixel values of pixels c,f,i=(C+2D+E+2)>>2

Prediction pixel values of pixels d,g,j,m=(D+2E+F+2)>>2

Prediction pixel values of pixels h,k,n=(E+2F+G+2)>>2

Prediction pixel values of pixels l,o=(F+2G+H+2)>>2

Prediction pixel value of pixel p=(G+3H+2)>>2 (19)

Mode 4 is a Diagonal_Down_Right Prediction mode, and is applied only in the event that pixel values A, B, C, D, I, J, K, L, M are “available”. In this case, the prediction pixel values of the pixels a through p are generated as in the following Expression (20).

Prediction pixel value of pixel m=(J+2K+L+2)>>2

Prediction pixel values of pixels i,n=(I+2J+K+2)>>2

Prediction pixel values of pixels e,j,o=(M+2I+J+2)>>2

Prediction pixel values of pixels a,f,k,p=(A+2M+I+2)>>2

Prediction pixel values of pixels b,g,l=(M+2A+B+2)>>2

Prediction pixel values of pixels c,h=(A+2B+C+2)>>2

Prediction pixel value of pixel d=(B+2C+D+2)>>2 (20)

Mode 5 is a Diagonal_Vertical_Right Prediction mode, and is applied only in the event that pixel values A, B, C, D, I, J, K, L, M are “available”. In this case, the prediction pixel values of the pixels a through p are generated as in the following Expression (21).

Prediction pixel value of pixels a,j=(M+A+1)>>1

Prediction pixel value of pixels b,k=(A+B+1)>>1

Prediction pixel value of pixels c,l=(B+C+1)>>1

Prediction pixel value of pixel d=(C+D+1)>>1

Prediction pixel value of pixels e,n=(I+2M+A+2)>>2

Prediction pixel value of pixels f,o=(M+2A+B+2)>>2

Prediction pixel value of pixels g,p=(A+2B+C+2)>>2

Prediction pixel value of pixel h=(B+2C+D+2)>>2

Prediction pixel value of pixel i=(M+2I+J+2)>>2

Prediction pixel value of pixel m=(I+2J+K+2)>>2 (21)

Mode 6 is a Horizontal_Down Prediction mode, and is applied only in the event that pixel values A, B, C, D, I, J, K, L, M are “available”. In this case, the prediction pixel values of the pixels a through p are generated as in the following Expression (22).

Prediction pixel values of pixels a,g=(M+I+1)>>1

Prediction pixel values of pixels b,h=(I+2M+A+2)>>2

Prediction pixel value of pixel c=(M+2A+B+2)>>2

Prediction pixel value of pixel d=(A+2B+C+2)>>2

Prediction pixel values of pixels e,k=(I+J+1)>>1

Prediction pixel values of pixels f,l=(M+2I+J+2)>>2

Prediction pixel values of pixels i,o=(J+K+1)>>1

Prediction pixel values of pixels j,p=(I+2J+K+2)>>2

Prediction pixel value of pixel m=(K+L+1)>>1

Prediction pixel value of pixel n=(J+2K+L+2)>>2 (22)

Mode 7 is a Vertical_Left Prediction mode, and is applied only in the event that pixel values A, B, C, D, I, J, K, L, M are “available”. In this case, the prediction pixel values of the pixels a through p are generated as in the following Expression (23).

Prediction pixel value of pixel a=(A+B+1)>>1

Prediction pixel values of pixels b,i=(B+C+1)>>1

Prediction pixel values of pixels c,j=(C+D+1)>>1

Prediction pixel values of pixels d,k=(D+E+1)>>1

Prediction pixel value of pixel l=(E+F+1)>>1

Prediction pixel value of pixel e=(A+2B+C+2)>>2

Prediction pixel values of pixels f,m=(B+2C+D+2)>>2

Prediction pixel values of pixels g,n=(C+2D+E+2)>>2

Prediction pixel values of pixels h,o=(D+2E+F+2)>>2

Prediction pixel value of pixel p=(E+2F+G+2)>>2 (23)

Mode 8 is a Horizontal_Up Prediction mode, and is applied only in the event that pixel values A, B, C, D, I, J, K, L, M are “available”. In this case, the prediction pixel values of the pixels a through p are generated as in the following Expression (24).

Prediction pixel value of pixel a=(I+J+1)>>1

Prediction pixel value of pixels b=(I+2J+K+2)>>2

Prediction pixel values of pixels c,e=(J+K+1)>>1

Prediction pixel values of pixels d,f=(J+2K+L+2)>>2

Prediction pixel values of pixels g,i=(K+L+1)>>1

Prediction pixel values of pixels h,j=(K+3L+2)>>2

Prediction pixel values of pixels k,l,m,n,o,p=L (24)

Next, the intra prediction mode (Intra_{—}4×4_pred_mode) encoding method for 4×4 pixel luminance signals will be described with reference to FIG. 20. In the example in FIG. 20, an current block C to be encoded which is made up of 4×4 pixels is shown, and a block A and block B which are made up of 4×4 pixel and are adjacent to the current block C are shown.

In this case, the Intra_{—}4×4_pred_mode in the current block C and the Intra_{—}4×4_pred_mode in the block A and block B are thought to have high correlation. Performing the following encoding processing using this correlation allows higher encoding efficiency to be realized.

That is to say, in the example in FIG. 20, with the Intra_{—}4×4_pred_mode in the block A and block B as Intra_{—}4×4_pred_modeA and Intra_{—}4×4_pred_modeB respectively, the MostProbableMode is defined as the following Expression (25).

MostProbableMode=Min(Intra_{—}4×4_pred_modeA,Intra_{—}4×4_pred_modeB) (25)

That is to say, of the block A and block B, that with the smaller mode_number allocated thereto is taken as the MostProbableMode.

There are two values of prev_intra4×4_pred_mode_flag[luma4×4BlkIdx] and rem_intra4×4_pred_mode[luma4×4BlkIdx] defined as parameters as to the current block C in the bit stream, with decoding processing being performed by processing based on the pseudocode shown in the following Expression (26), so the values of Intra_{—}4×4_pred_mode, Intra4×4PredMode[luma4×4BlkIdx] as to the current block C can be obtained.

```
    if(prev_intra4×4_pred_mode_flag[luma4×4BlkIdx])
        Intra4×4PredMode[luma4×4BlkIdx] = MostProbableMode
    else
        if(rem_intra4×4_pred_mode[luma4×4BlkIdx] <
MostProbableMode)
        Intra4×4PredMode[luma4×4BlkIdx] =
rem_intra4×4_pred_mode[luma4×4BlkIdx]
    else
        Intra4×4PredMode[luma4×4BlkIdx] =
rem_intra4×4_pred_mode[luma4×4BlkIdx] + 1
    ...(26)
```

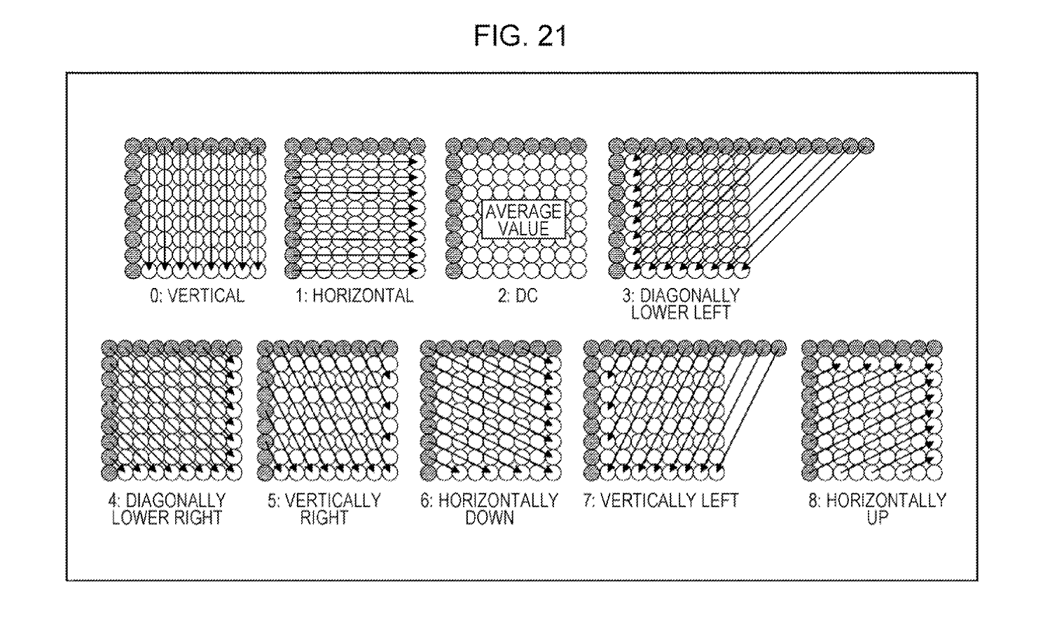

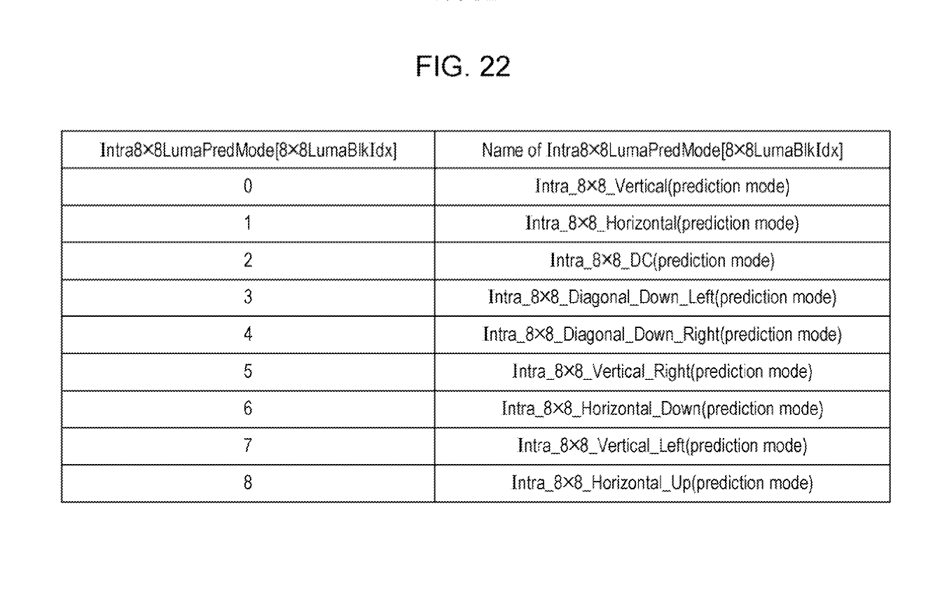

Next, the 8×8-pixel intra prediction mode will be described. FIG. 21 and FIG. 22 are diagrams showing the nine kinds of 8×8-pixel intra prediction modes (intra_{—}8×8_pred_mode) for luminance signals.

Let us say that the pixel values in the current 8×8 block are taken as p[x, y] (0≦x≦7; 0≦y≦7), and the pixel values of an adjacent block are represented as with p[−1, −1], . . . , p[−1, 15], p[−1, 0], . . . , [p−1, 7].

With regard to the 8×8-pixel intra prediction modes, adjacent pixels are subjected to low-pass filtering processing prior to generating a prediction value. Now, let us say that pixel values before low-pass filtering processing are represented with p[−1, −1], . . . , p[−1, 15], p[−1, 0], . . . , p[−1, 7], and pixel values after the processing are represented with p′[−1, −1], . . . , p′[−1, 15], p′[−1, 0], . . . , p′[−1, 7].

First, p′[0, −1] is calculated as with the following Expression (27) in the event that p[−1, −1] is “available”, and calculated as with the following Expression (28) in the event of “not available”.

p′[0,−1]=(p[−1,−1]+2*p[0,−1]+p[1,−1]+2)>>2 (27)

p′[0,−1]=(3*p[0,−1]+p[1,−1]+2)>>2 (28)

p′[x, −1] (x=0, . . . , 7) is calculated as with the following Expression (29).

p′[x,−1]=(p[x−1,−1]+2*p[x,−1]+p[x+1,−1]+2)>>2 (29)

p′[x, −1] (x=8, . . . , 15) is calculated as with the following Expression (30) in the event that p[x, −1] (x=8, . . . , 15) is “available”.

p′[x,−1]=(p[x−1,−1]+2*p[x,−1]+p[x+1,−1]+2)>>2

p′[15,−1]=(p[14,−1]+3*p[15,−1]+2)>>2 (30)

p′[−1, −1] is calculated as follows in the event that p[−1, −1] is “available”. Specifically, p′[−1, −1] is calculated as with Expression (31) in the event that both of p[0, −1] and p[−1, 0] are “available”, and calculated as with Expression (32) in the event that p[−1, 0] is “unavailable”. Also, p′[−1, −1] is calculated as with Expression (33) in the event that p[0, −1] is “unavailable”.

p′[−1,−1]=(p[0,−1]+2*p[−1,−1]+p[−1,0]+2)>>2 (31)

p′[−1,−1]=(3*p[−1,−1]+p[0,−1]+2)>>2 (32)

p′[−1,−1]=(3*p[−1,−1]+p[−1,0]+2)>>2 (33)

p′[−1, y] (y=0, . . . , 7) is calculated as follows when p[−1, y] (y=0, . . . , 7) is “available”. Specifically, first, in the event that p[−1, −1] is “available”, p′[−1, 0] is calculated as with the following Expression (34), and in the event of “unavailable”, calculated as with Expression (35).

p′[−1,0]=(p[−1,−1]+2*p[−1,0]+p[−1,1]+2)>>2 (34)

p′[−1,0]=(3*p[−1,0]+p[−1,1]+2)>>2 (35)

Also, p′[−1, y] (y=1, . . . , 6) is calculated as with the following Expression (36), and p′[−1, 7] is calculated as with Expression (37).

p[−1,y]=(p[−1,y−1]+2*p[−1,y]+p[−1,y+1]+2)>>2 (36)

p′[−1,7]=(p[−1,6]+3*p[−1,7]+2)>>2 (37)

Prediction values in the intra prediction modes shown in FIG. 21 and FIG. 22 are generated as follows using p′ thus calculated.

The mode 0 is a Vertical Prediction mode, and is applied only when p[x, −1] (x=0, . . . , 7) is “available”. A prediction value pred8×8_{L}[x, y] is generated as with the following Expression (38).

pred8×8_{L}[x,y]=p′[x,−1] x,y=0, . . . ,7 (38)

The mode 1 is a Horizontal Prediction mode, and is applied only when p[−1, y] (y=0, . . . , 7) is “available”. The prediction value pred8×8_{L}[x, y] is generated as with the following Expression (39).

pred8×8_{L}[x,y]=p′[−1,y] x,y=0, . . . ,7 (39)

The mode 2 is a DC Prediction mode, and the prediction value pred8×8_{L}[x, y] is generated as follows. Specifically, in the event that both of p[x, −1] (x=0, . . . , 7) and p[−1, y] (y=0, . . . , 7) are “available”, the prediction value pred8×8_{L}[x, y] is generated as with the following Expression (40).

$$\begin{matrix} \{ Mathematical Expression 5 ] & \\ Pred 8 \times {8}_{L} [ x , y ] = ( {\sum }_{{x}^{′} = 0}^{7} {P}^{′} [ {x}^{′} , - 1 ] + {\sum }_{{y}^{′} = 0}^{7} {P}^{′} [ - 1 , y ] + 8 ) >> 4 & ( 40 )\end{matrix}$$

In the event that p[x, −1] (x=0, . . . , 7) is “available”, but p[−1, y] (y=0, . . . , 7) is “unavailable”, the prediction value pred8×8_{L}[x, y] is generated as with the following Expression (41).

$$\begin{matrix}\{ Mathematical Expression 6 ] & \\ Pred 8 \times {8}_{L} [ x , y ] = ( {\sum }_{{x}^{′} = 0}^{7} {P}^{′} [ {x}^{′} , - 1 ] + 4 ) >> 3 & ( 41 )\end{matrix}$$

In the event that p[x, −1] (x=0, . . . , 7) is “unavailable”, but p[−1, y] (y=0, . . . , 7) is “available”, the prediction value pred8×8_{L}[x, y] is generated as with the following Expression (42).

$$\begin{matrix}\{ Mathematical Expression 7 ] & \\ Pred 8 \times {8}_{L} [ x , y ] = ( {\sum }_{{y}^{′} = 0}^{7} {P}^{′} [ - 1 , y ] + 4 ) >> 3 & ( 42 )\end{matrix}$$

In the event that both of p[x, −1] (x=0, . . . , 7) and p[−1, y] (y=0, . . . , 7) are “unavailable”, the prediction value pred8×8_{L}[x, y] is generated as with the following Expression (43).

pred8×8_{L}[x,y]=128 (43)

Here, Expression (43) represents a case of 8-bit input.

The mode 3 is a Diagonal_Down_Left_prediction mode, and the prediction value pred8×8_{L}[x, y] is generated as follows. Specifically, the Diagonal_Down_Left_prediction mode is applied only when p[x, −1], x=0, . . . , 15, is “available”, and the prediction pixel value with x=7 and y=7 is generated as with the following Expression (44), and other prediction pixel values are generated as with the following Expression (45).

pred8×8_{L}[x,y]=(p′[14,−1]+3*p[15,−1]+2)>>2 (44)

pred8×8_{L}[x,y]=(p′[x+y,−1]+2*p′[x+y+1,−1]+p′[x+y+2,−1]+2)>>2 (45)

The mode 4 is a Diagnonal_Down_Right_prediction mode, and the prediction value pred8×8_{L}[x, y] is generated as follows. Specifically, the Diagnonal_Down_Right_prediction mode is applied only when p[x, −1], x=0, . . . , 7 and p[−1, y], y=0, . . . , 7 are “available”, the prediction pixel value with x>y is generated as with the following Expression (46), and the prediction pixel value with x<y is generated as with the following Expression (47). Also, the prediction pixel value with x=y is generated as with the following Expression (48).

pred8×8_{L}[x,y]=(p′[x−y−2,−1]+2*p′[x−y−1,−1]+p′[x−y,−1]+2)>>2 (46)

pred8×8_{L}[x,y]=(p′[−1,y−x−2]+2*p′[−1,y−x−1]+p′[−1,y−x]+2)>>2 (47)

pred8×8_{L}[x,y]=(p′[0,−1]+2*p′[−1,−1]+p′[−1,0]+2)>>2 (48)

The mode 5 is a Vertical_Right_prediction mode, and the prediction value pred8×8_{L}[x, y] is generated as follows. Specifically, the Vertical_Right_prediction mode is applied only when p[x, −1], x=0, . . . , 7 and p[−1, y], y=−1, . . . 7 are “available”. Now, zVR is defined as with the following Expression (49).

zVR=2*x−y (49)

At this time, in the event that zVR is 0, 2, 4, 6, 8, 10, 12, or 14, the pixel prediction value is generated as with the following Expression (50), and in the event that zVR is 1, 3, 5, 7, 9, 11, or 13, the pixel prediction value is generated as with the following Expression (51).

pred8×8_{L}[x,y]=(p′[x−(y>>1)−1,−1]+p′[x−(y>>1),−1]+1)>>1 (50)

pred8×8_{L}[x,y]=(p′[x−(y>>1)−2,−1]+2*p′[x−(y>>1)−1,−1]+p′[x−(y>>1),−1]+2)>>2 (51)

Also, in the event that zVR is −1, the pixel prediction value is generated as with the following Expression (52), and in the cases other than this, specifically, in the event that zVR is −2, −3, −4, −5, −6, or −7, the pixel prediction value is generated as with the following Expression (53).

pred8×8_{L}[x,y]=(p′[−1,0]+2*p′[−1,−1]+p′[0,−1]+2)>>2 (52)

pred8×8_{L}[x,y]=(p′[−1,y−2*x−1]+2*p′[−1,y−2*x−2]+p′[−1,y−2*x−3]+2)>>2 (53)

The mode 6 is a Horizontal_Down_prediction mode, and the prediction value pred8×8_{L}[x, y] is generated as follows. Specifically, the Horizontal_Down_prediction mode is applied only when p[x, −1], x=0, . . . , 7 and p[−1, y], y=−1, . . . , 7 are “available”. Now, zVR is defined as with the following Expression (54).

zHD=2*y−x (54)

At this time, in the event that zHD is 0, 2, 4, 6, 8, 10, 12, or 14, the prediction pixel value is generated as with the following Expression (55), and in the event that zHD is 1, 3, 5, 7, 9, 11, or 13, the prediction pixel value is generated as with the following Expression (56).

pred8×8_{L}[x,y]=(p′[−1,y−(x>>1)−1]+p′[−1,y−(x>>1)+1]>>1 (55)

pred8×8_{L}[x,y]=(p′[−1,y−(x>>1)−2]+2*p′[−1,y−(x>>1)−1]+p′[−1,y−(x>>1)]+2)>>2 (56)

Also, in the event that zHD is −1, the prediction pixel value is generated as with the following Expression (57), and in the event that zHD is other than this, specifically, in the event that zHD is −2, −3, −4, −5, −6, or −7, the prediction pixel value is generated as with the following Expression (58).

pred8×8_{L}[x,y]=(p′[−1,0]+2*p[−1,−1]+p′[0,−1]+2)>>2 (57)

pred8×8_{L}[x,y]=(p′[x−2*y−1,−1]+2*p′[x−2*y−2,−1]+p′[x−2*y−3,−1]+2)>>2 (58)

The mode 7 is a Vertical_Left_prediction mode, and the prediction value pred8×8_{L}[x, y] is generated as follows. Specifically, the Vertical_Left_prediction mode is applied only when p[x, −1], x=0, . . . , 15, is “available”, in the case that y=0, 2, 4, or 6, the prediction pixel value is generated as with the following. Expression (59), and in the cases other than this, i.e., in the case that y=1, 3, 5, or 7, the prediction pixel value is generated as with the following Expression (60).

pred8×8_{L}[x,y]=(p′[x+(y>>1),−1]+p′[x+(y>>1)+1,−1]+1)>>1 (59)

pred8×8_{L}[x,y]=(p′[x+(y>>1),−1]+2*p′[x+(y>>1)+1,−1]+p′[x+(y>>1)+2,−1]+2)>>2 (60)

The mode 8 is a Horizontal_Up_prediction mode, and the prediction value pred8×8_{L}[x, y] is generated as follows. Specifically, the Horizontal_Up_prediction mode is applied only when p[−1, y], y=0, . . . , 7, is “available”. Hereafter, zHU is defined as with the following Expression (61).

zHU=x+2*y (61)

In the event that the value of zHU is 0, 2, 4, 6, 8, 10, 12, the prediction pixel value is generated as with the following Expression (62), and in the event that the value of zHU is 1, 3, 5, 7, 9, or 11, the prediction pixel value is generated as with the following Expression (63).

pred8×8_{L}[x,y]=(p′[−1,y+(x>>1)]+p′[−1,y+(x>>1)+1]+1)>>1 (62)

pred8×8_{L}[x,y]=(p′[−1,y+(x>>1)] (63)

Also, in the event that the value of zHU is 13, the prediction pixel value is generated as with the following Expression (64), and in the cases other than this, i.e., in the event that the value of zHU is greater than 13, the prediction pixel value is generated as with the following Expression (65).

pred8×8_{L}[x,y]=(p′[−1,6]+3*p′[−1,7]+2)>>2 (64)

pred8×8_{L}[x,y]=p′[−1,7] (65)

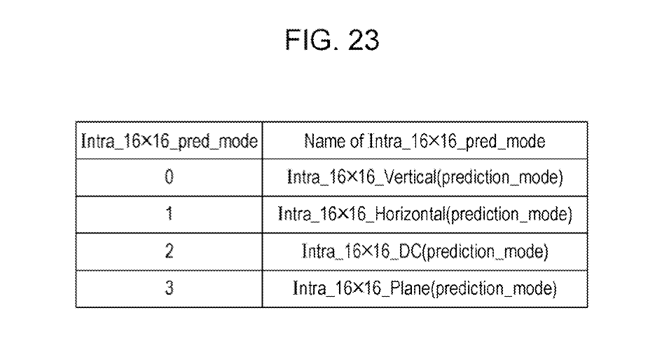

Next, the 16×16 pixel intra prediction mode will be described. FIG. 23 and FIG. 24 are diagrams illustrating the four types of 16×16 pixels luminance signal intra prediction modes (Intra_{—}16×16_pred_mode).

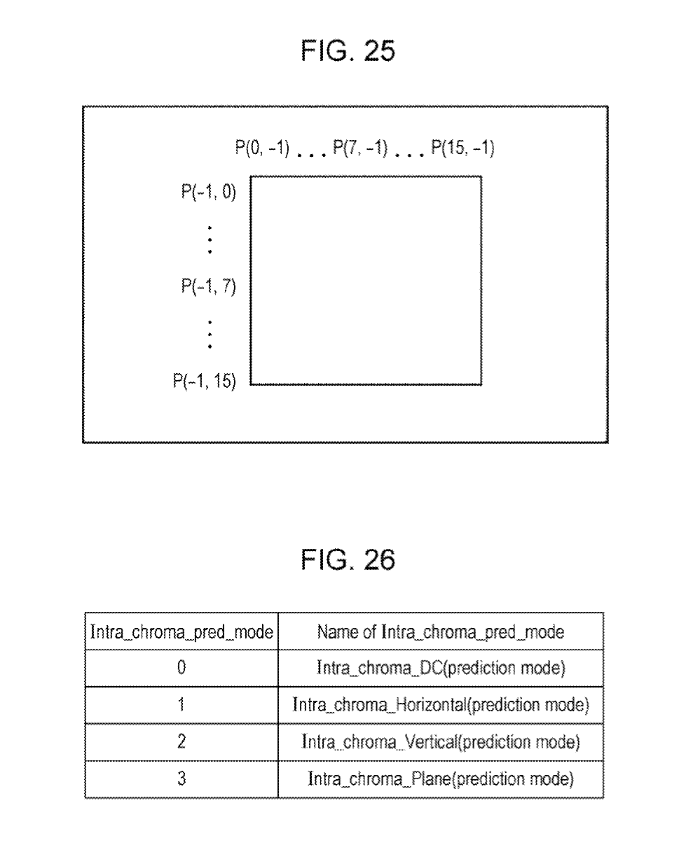

The four types of intra prediction modes will be described with reference to FIG. 25. In the example in FIG. 25, an current macro block A to be subjected to intra processing is shown, and P(x,y); x,y=−1, 0, . . . , 15 represents the pixel values of the pixels adjacent to the current macro block A.

Mode 0 is the Vertical Prediction mode, and is applied only in the event that P(x,−1); x,y=−1, 0, . . . , 15 is “available”. In this case, the prediction pixel value Pred(x, y) of each of the pixels in the current macro block A is generated as in the following Expression (66).

Pred(x,y)=P(x,−1); x,y=0, . . . ,15 (66)

Mode 1 is the Horizontal Prediction mode, and is applied only in the event that P(−1,y); x,y=−1, 0, . . . , 15 is “available”. In this case, the prediction pixel value Pred(x, y) of each of the pixels in the current macro block A is generated as in the following Expression (67).

Pred(x,y)=P(−1,y); x,y=0, . . . ,15 (67)

Mode 2 is the DC Prediction mode, and in the event that P(x,−1) and P(−1,y); x,y=−1, 0, . . . , 15 are all “available”, the prediction pixel value Pred(x, y) of each of the pixels in the current macro block A is generated as in the following Expression (68).

$$\begin{matrix}\{ Mathematical Expression 8 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with \\ x , y = 0 , … , 15 & ( 68 )\end{matrix}$$

Also, in the event that P(x,−1); x,y=−1, 0, . . . , 15 is “unavailable”, the prediction pixel value Pred(x, y) of each of the pixels in the current macro block A is generated as in the following Expression (69).

$$\begin{matrix}\{ Mathematical Expression 9 ] & \\ Pred ( x , y ) = [ {\sum }_{{y}^{′} = 0}^{15} P ( - 1 , {y}^{′} ) + 8 ] >> 4 \\ with \\ x , y = 0 , … , 15 & ( 69 )\end{matrix}$$

In the event that P(−1,y); x,y=−1, 0, . . . , 15 is “unavailable”, the prediction pixel value Pred(x, y) of each of the pixels in the current macro block A is generated as in the following Expression (70).

$$\begin{matrix}\{ Mathematical Expression 10 ] & \\ Pred ( x , y ) = [ {\sum }_{{y}^{′} = 0}^{15} P ( {x}^{′} , - 1 ) + 8 ] >> 4 \\ with \\ x , y = 0 , … , 15 & ( 70 )\end{matrix}$$

In the event that P(x,−1) and P(−1,y); x,y=−1, 0, . . . , 15 are all “unavailable”, 128 is used as a prediction pixel value.

Mode 3 is the Plane Prediction mode, and is applied only in the event that P(x,−1) and P(−1,y); x,y=−1, 0, . . . , 15 are all “available”. In this case, the prediction pixel value Pred(x, y) of each of the pixels in the current macro block A is generated as in the following Expression (71).

$$\begin{matrix}\{ Mathematical Expression 11 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} \times \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 71 )\end{matrix}$$

Next, the intra prediction modes as to color difference signals will be described. FIG. 26 is a diagram illustrating the four types of color difference signal intra prediction modes (Intra_chroma_pred_mode). The color difference signal intra prediction mode can be set independently from the luminance signal intra prediction mode. The intra prediction mode for color difference signals conforms to the above-described luminance signal 16×16 pixel intra prediction mode.

Note however, that while the luminance signal 16×16 pixel intra prediction mode handles 16×16 pixel blocks, the intra prediction mode for color difference signals handles 8×8 pixel blocks. Further, the mode Nos. do not correspond between the two, as can be seen in FIG. 23 and FIG. 26 described above.

Now, this conforms to the definition of pixel values of the current macro block A which is the object of the luminance signal 16×16 pixel intra prediction mode and the adjacent pixel values described above with reference to FIG. 25. The pixel values adjacent to the current macro block A for intra processing (8×8 pixels in the case of color difference signals) will be taken as P(x,y); x,y=−1, 0, . . . , 7.

Mode 0 is the DC Prediction mode, and in the event that P(x, −1) and P (−1, y); x, y=−1, 0, . . . , 7 are all “available”, the prediction pixel value Pred(x,y) of each of the pixels of the current macro block A is generated as in the following Expression (72).

$$\begin{matrix}\{ Mathematical Expression 12 ] & \\ Pred ( x , y ) = ( ( {\sum }_{{x}^{′} = 0}^{7} ( P ( - 1 , n ) + P ( n , - 1 ) ) ) + 8 ) >> 4 \\ with \\ x , y = 0 , … , 7 & ( 72 )\end{matrix}$$

Also, in the event that P(−1,y); x,y=−1, 0, . . . , 7 is “unavailable”, the prediction pixel value Pred(x,y) of each of the pixels of current macro block A is generated as in the following Expression (73).

$$\begin{matrix}\{ Mathematical Expression 13 ] & \\ Pred ( x , y ) = [ ( {\sum }_{n = 0}^{7} P ( n , - 1 ) ) + 4 ] >> 3 \\ with \\ x , y = 0 , … , 7 & ( 73 )\end{matrix}$$

Also, in the event that P(x,−1); x,y=−1, 0, . . . , 7 is “unavailable”, the prediction pixel value Pred(x,y) of each of the pixels of current macro block A is generated as in the following Expression (74).

$$\begin{matrix}\{ Mathematical Expression 14 ] & \\ Pred ( x , y ) = [ ( {\sum }_{n = 0}^{7} P ( - 1 , n ) ) + 4 ] >> 3 \\ with \\ x , y = 0 , … , 7 & ( 74 )\end{matrix}$$

Mode 1 is the Horizontal Prediction mode, and is applied only in the event that P(−1,y); x,y=−1, 0, . . . , 7 is “available”. In this case, the prediction pixel value Pred(x,y) of each of the pixels of current macro block A is generated as in the following Expression (75).

Pred(x,y)=P(−1,y); x,y=0, . . . ,7 (75)

Mode 2 is the Vertical Prediction mode, and is applied only in the event that P(x,−1); x,y=−1, 0, . . . , 7 is “available”. In this case, the prediction pixel value Pred(x,y) of each of the pixels of current macro block A is generated as in the following Expression (76).

Pred(x,y)=P(x,−1); x,y=0, . . . ,7 (76)

Mode 3 is the Plane Prediction mode, and is applied only in the event that P(x,−1) and P(−1,y); x,y=−1, 0, . . . , 7 are “available” In this case, the prediction pixel value Pred(x,y) of each of the pixels of current macro block A is generated as in the following Expression (77).

$$\begin{matrix}\{ Mathematical Expression 15 ] & \\ Pred ( x , y ) = Clip 1 ( ( a + b \cdot ( x - 3 ) + c \cdot ( y - 3 ) + 16 ) >> 5 ) ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 5 \\ H = {\sum }_{x - 1}^{4} \times \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 77 )\end{matrix}$$

As described above, there are nine types of 4×4 pixel and 8×8 pixel block-increment and four types of 16×16 pixel macro block-increment prediction modes for luminance signal intra prediction modes in the block increments, and there are four types of 8×8 pixel block-increment prediction modes for color difference signal intra prediction modes. The color difference signal intra prediction mode can be set separately from the luminance signal intra prediction mode.

Also, the luminance signal 4×4 pixel intra prediction modes (intra 4×4 prediction mode) and 8×8 pixel intra prediction modes (intra 8×8 prediction mode), one intra prediction mode is defined for each 4×4 pixel and 8×8-pixel luminance signal block. For luminance signal 16×16 pixel intra prediction modes (intra 16×16 prediction mode) and color difference signal intra prediction modes, one prediction mode is defined for each macro block.

Note that the types of prediction modes correspond to the directions indicated by the Nos. 0, 1, 3 through 8, in FIG. 18 described above. Prediction mode 2 is an average value prediction.

### [Description of Intra Prediction Processing]

Next, the intra prediction processing in step S31 of FIG. 14, which is processing performed as to these prediction modes, will be described with reference to the flowchart in FIG. 27. Note that in the example in FIG. 27, the case of luminance signals will be described as an example.

In step S41, the intra prediction unit 74 performs intra prediction as to each intra prediction mode of 4×4 pixels, 8×8 pixels, and 16×16 pixels.

Specifically, the intra prediction unit 74 makes reference to the decoded image to be processed that has been read out from the frame memory 72 and supplied to the intra prediction unit 74 via the switch 73, and performs intra prediction. Performing this intra prediction processing in each intra prediction mode results in a prediction image being generated in each intra prediction mode. Note that pixels not subject to deblocking filtering by the deblocking filter 71 are used as the decoded pixels to be referenced.

In step S42, the intra prediction unit 74 calculates cost function values for each intra prediction mode of 4×4 pixels, 8×8 pixels, and 16×16 pixels. Now, one technique of either a High Complexity mode or a Low Complexity mode is used for cost function values, as stipulated in JM (Joint Model) which is reference software in the H.264/AVC format.

That is to say, with the High Complexity mode, as far as temporary encoding processing is performed for all candidate prediction modes as the processing of step S41, a cost function value is calculated for each prediction mode as shown in the following Expression (78), and the prediction mode which yields the smallest value is selected as the optimal prediction mode.

Cost(Mode)=D+λ·R (78)

D is difference (noise) between the original image and decoded image, R is generated code amount including orthogonal transform coefficients, and λ is a Lagrange multiplier given as a function of a quantization parameter QP.

On the other hand, in the Low Complexity mode, as for the processing of step S41, prediction images are generated and calculation is performed as far as the header bits such as motion vector information and prediction mode information, flag information and so forth, for all candidates prediction modes, a cost function value shown in the following Expression (79) is calculated for each prediction mode, and the prediction mode yielding the smallest value is selected as the optimal prediction mode.

Cost(Mode)=D+QPtoQuant(QP)·Header_Bit (79)

D is difference (noise) between the original image and decoded image, Header_Bit is header bits for the prediction mode, and QPtoQuant is a function given as a function of a quantization parameter QP.

In the Low Complexity mode, just a prediction image is generated for all prediction modes, and there is no need to perform encoding processing and decoding processing, so the amount of computation that has to be performed is small.

In step S43, the intra prediction unit 74 determines an optimal mode for each intra prediction mode of 4×4 pixels, 8×8 pixels, and 16×16 pixels. That is to say, as described above, there are nine types of prediction modes for intra 4×4 prediction mode and intra 8×8 prediction mode, and there are four types of prediction modes for intra 16×16 prediction mode. Accordingly, the intra prediction unit 74 determines from these an optimal intra 4×4 prediction mode, an optimal intra 8×8 prediction mode, and an optimal intra 16×16 prediction mode, based on the cost function value calculated in step S42.

In step S44, the intra prediction unit 74 selects one optimal intra prediction mode from the optimal modes decided for each intra prediction mode of 4×4 pixels, 8×8 pixels, and 16×16 pixels, based on the cost function value calculated in step S42. That is to say, the optimal intra prediction mode of which the cost function value is the smallest is selected from the optimal modes decided for each of 4×4 pixels, 8×8 pixels, and 16×16 pixels. The intra prediction unit 74 then supplies the prediction image generated in the optimal intra prediction mode, and the cost function value thereof, to the prediction image selecting unit 78.

### [Description of Inter Motion Prediction Processing]

Next, the inter motion prediction processing in step S32 in FIG. 14 will be described with reference to the flowchart in FIG. 28.

In step S51, the motion prediction/compensation unit 75 determines a motion vector and a reference image as to each of the eight kinds of the inter prediction modes made up of 16×16 pixels through 4×4 pixels, described above with reference to FIG. 4. That is to say, a motion vector and a reference image are each determined as to the block to be processed in each of the inter prediction modes.

In step S52, the motion prediction/compensation unit 75 subjects the reference image to motion prediction and compensation processing based on the motion vector determined in step S51 regarding each of the eight kinds of the inter prediction modes made up of 16×16 pixels through 4×4 pixels. According to this motion prediction and compensation processing, a prediction image in each of the inter prediction modes is generated for each current block from the pixel values of the reference block, and the first order residue which is the difference between the current block and the prediction image thereof is output to the second order prediction unit 75. Also, the detected motion vector information and address of image to be subjected to inter processing are also output from the motion prediction/compensation unit 75 to the second order prediction unit 76.

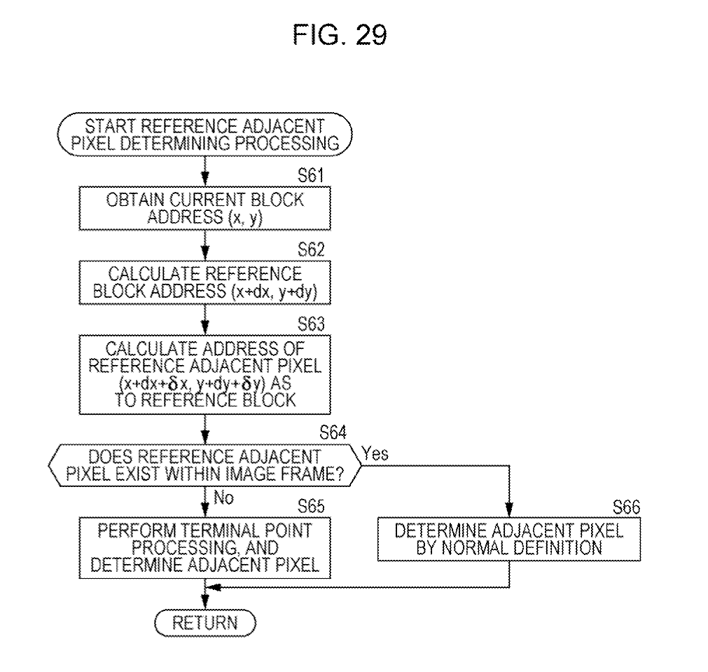

In step S53, the second order prediction unit 76 and reference adjacent determining unit 77 perform reference adjacent pixel determining processing. The details of this reference adjacent pixel determining processing will be described in detail later with reference to FIG. 29.

Due to the processing in step S53, determination is made regarding whether reference adjacent pixels adjacent to the reference block exist within the image frame of the reference frame, and terminal point processing is performed according to the determination results thereof, thereby determining the pixel values of the reference adjacent pixels.

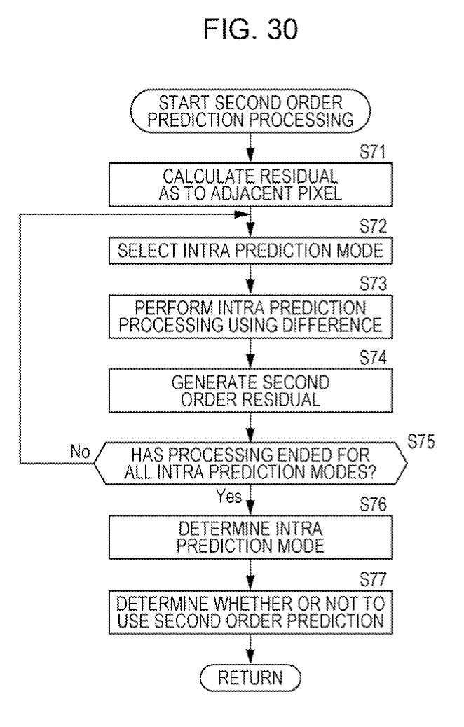

In step S54, the second order prediction unit 76 and motion prediction/compensation unit 75 perform second order prediction processing using the determined reference adjacent pixels. The details of this second order prediction processing will be described in detail later with reference to FIG. 30.

Due to the processing in step S54, prediction is performed between the first order residue which is the difference between the current block image and prediction image, and the difference between the current adjacent pixels and reference adjacent pixels, thereby generating second order residue. The first order residue and second order residue are compared, thereby determining whether or not to perform, second order prediction processing.

In the event that determination has been made to perform second order prediction, the second order residue is used to calculation of cost function values in later-described step S56, instead of the first order residue. In this case, a second order prediction flag indicating that second order prediction is to be performed, and information indicating the intra prediction mode in second order prediction, are also output to the motion prediction/compensation unit 75.

In step S55, the motion prediction/compensation unit 75 generates motion vector information mvd_{E} regarding the motion vector determined as to each of the eight kinds of inter prediction modes made up of 16×16 pixels through 4×4 pixels. At this time, the motion vector generating method described above with reference to FIG. 7 is used.

The generated motion vector information is also used at the time of calculation of cost function value in the next step S56, and output, in the event that the corresponding prediction image has ultimately been selected by the prediction image selecting unit 78, to the lossless encoding unit 66 along with the prediction mode information and reference frame information.

In step S56, mode determining unit 86 calculates the cost function value shown in the above-described Expression (78) or Expression (79) as to each of the eight kinds of the inter prediction modes made up of 16×16 pixels through 4×4 pixels. The cost function values calculated here are used at the time of determining the optimal inter prediction mode in step S33 in FIG. 14 described above.

### [Description of Reference Adjacent Pixel Determining Processing]

Next, the reference adjacent pixel determining processing in step S53 of FIG. 28 will be described with reference to the flowchart in FIG. 29.

The current block address (x, y) from the motion prediction/compensation unit 75 is supplied to the reference block address calculating unit 81 and current adjacent pixel readout unit 84. In step S61, the reference block address calculating unit 81 obtains the current block address (x, y).

Also, the motion vector information (dx, dy) obtained in step S51 in FIG. 28 regarding the current block is input to the reference block address calculating unit 81. In step S62, the reference block address calculating unit 81 calculates a reference block address (x+dx, y+dy) from the current block address (x, y) and motion vector information (dx, dy), and supplies this to the reference adjacent address calculating unit 82.

In step S63, the reference adjacent address calculating unit 82 calculates a reference adjacent address (x+dx+δx, y+dy+δy) which is the addresses of the reference adjacent pixels as to the reference block, which is then supplied to the reference adjacent determining unit 77.

In step S64, based on the reference adjacent address (x dx+δx, y+dy+δy), the reference adjacent determining unit 77 determines whether or not reference adjacent pixels exist within the image frame, and supplies the determination results to the reference adjacent pixel determining unit 83. In the event that determination is made in step S64 that reference adjacent pixels do not exist within the image frame, in step S65 the reference adjacent pixel determining unit 83 performs the terminal processing described above with reference to FIG. 12 regarding the adjacent pixels which do not exist, and determines the pixel values of the reference adjacent pixels. The reference adjacent pixel determining unit 83 then reads out the determined pixel values from the frame memory 72, and stores these in an unshown built-in buffer as the pixel values of the reference adjacent pixels.

On the other hand, in the event that determination is made in step S64 that reference adjacent pixels exist within the image frame, the processing advances to step S66. In step S66 the reference adjacent pixel determining unit 83 determines the adjacent pixels according to normal definition, and reads out from the frame memory 72. That is to say, the reference adjacent pixel determining unit 83 reads out the pixel values of the reference adjacent pixels defined in the H.264/AVC format from the frame memory 72, and stores these in an unshown built-in buffer.

Next, the second order prediction processing in step S54 of FIG. 28 will be described with reference to the flowchart in FIG. 30. Note that the example in FIG. 30 is described regarding an example of intra prediction of 4×4 pixels.

The built-in buffer of the reference adjacent pixel determining unit 82 stores pixel values of reference adjacent pixels. Also, the current adjacent pixel readout unit 84 uses the current block address (x, y) from the motion prediction/compensation unit 75 to read out pixel values of the current block from the frame memory 72, and store these in an unshown built-in buffer.

The adjacent pixel difference calculating unit 85 reads out a current adjacent pixel [A′] from the built-in buffer of the current adjacent pixel readout unit 84, and also reads out a reference adjacent pixel [B′] corresponding to the current adjacent pixel from the built-in buffer of the reference adjacent pixel determining unit 85. In step S71, the adjacent pixel difference calculating unit 85 calculates the difference between the current adjacent pixel [A′] and reference adjacent pixel [B′] read out from the respective built-in buffers, and stores this as a residual [A′−B′] as to the adjacent pixel in an unshown built-in buffer.

In step S72, the intra prediction unit 86 selects one intra prediction mode of the nine types of intra prediction modes described above with FIG. 13 and FIG. 14. In step S73, the intra prediction unit 86 performs intra prediction processing using the difference (residual) in the selected intra prediction mode.

That is to say, the intra prediction unit 86 reads out the residual [A′−B′] as to the adjacent pixel from the built-in buffer of the adjacent pixel difference calculating unit 85. The intra prediction unit 86 then uses the residual [A′−B′] as to the read adjacent pixel to perform intra prediction regarding the current block in the selected intra prediction mode [mode], and generates an intra prediction image Ipred(A′−B′)[mode].

In step S74, the intra prediction unit 86 generates a second order residual. That is to say, upon generating the intra prediction image Ipred(A′−B′)[mode] by difference, the second order residual generating unit 82 reads out a first order residual (A−B) corresponding thereto from the current block difference buffer 87. The second order residual generating unit 82 generates a second order residual which is the difference between the first order residual and the intra prediction image Ipred(A′−B′)[mode], and outputs the generated second order residual to the motion prediction/compensation unit 75. At this time, the information of the intra prediction mode in the second order prediction that is corresponding is also output to the motion prediction/compensation unit 75.

In step S75, the adjacent pixel prediction unit 83 determines whether processing has ended for all intra prediction modes, and in the event that determination is made that this has not ended, returns to step S72, and repeats the subsequent processing. That is to say, in step S72, another intra prediction mode is selected, and subsequent processing is repeated.

In the event that determination is made in step S75 that processing as to all intra prediction modes has ended, the processing advances to step S76.

In step S76, the motion prediction/compensation unit 75 compares second order residual in each intra prediction mode from the second order prediction unit 76, and determines from these the intra prediction mode for the second order residual with the best encoding efficiency to be the intra prediction mode for the current block. That is to say, the intra prediction mode with the smallest second order residual value is determined as the intra prediction mode of the current block.

In step S77, the motion prediction/compensation unit 75 further compares the second order residual of the determined intra prediction mode with the first order residual, and determines whether or not to use second order prediction. That is to say, in the event that determination is made that the second order residual has better encoding efficiency, determination is made to use second order prediction, and the difference between the image to be subjected to inter and the second order residual is taken as a candidate of inter prediction for the prediction image. In the event that determination is made that the first order residual has better encoding efficiency, determination is made to not use second order prediction, and the prediction image obtained in step S52 in FIG. 28 is taken as the candidate for inter prediction.

That is to say, the second order residue is encoded and sent to the decoding side only in the event that the second order residual provides higher encoding efficiency than the first order residual.

Note that in step S77, an arrangement may be made wherein the values of the residues themselves are compared and that with the small value is determined has having better encoding efficiency, or an arrangement may be made wherein that with better encoding efficiency is determined by calculating cost function values indicated with the above-described Expression (78) or Expression (79).

As described above, in the event that reference adjacent pixels are outside the image frame, terminal point processing is performed to determine the pixel values of the reference adjacent pixels, so second order prediction can be performed even in the event that reference adjacent pixels are outside the image frame. Accordingly, encoding efficiency can be improved.

The encoded compressed image is transmitted over a predetermined transmission path, and is decoded by an image decoding device.

### [Configuration Example of Image Decoding Device]

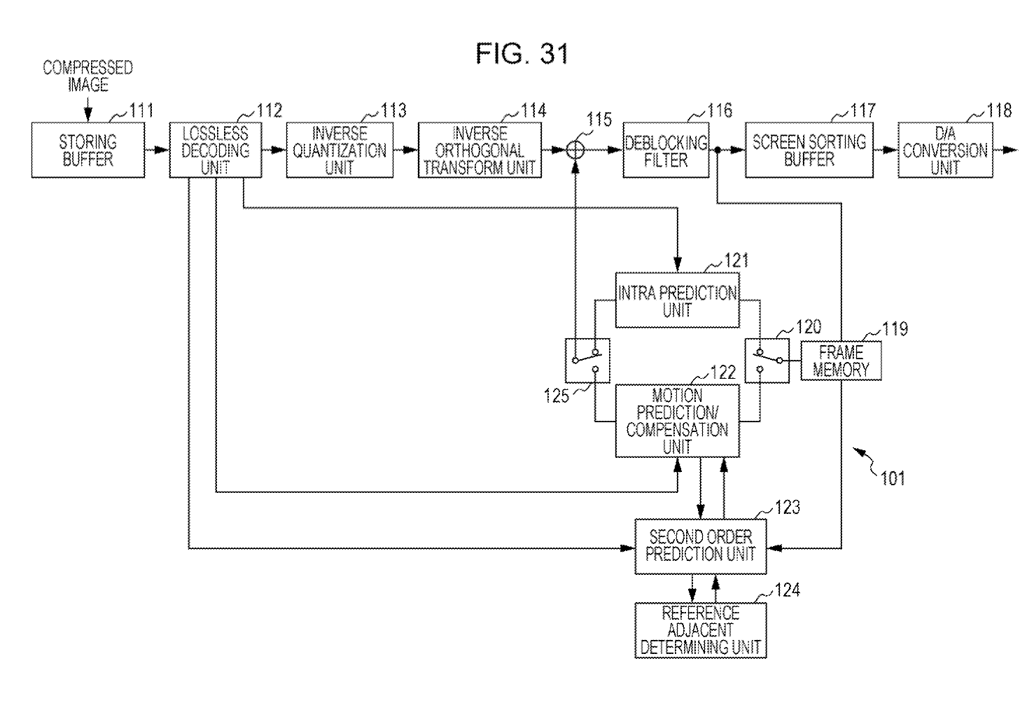

FIG. 31 represents the configuration of an embodiment of an image decoding device serving as the image processing device to which the present invention has been applied.

An image decoding device 101 is configured of an storing buffer 111, a lossless decoding unit 112, an inverse quantization unit 113, an inverse orthogonal transform unit 114, a computing unit 115, a deblocking filter 116, a screen sorting buffer 117, a D/A conversion unit 118, frame memory 119, a switch 120, an intra prediction unit 121, a motion prediction/compensation unit 122, a second order prediction unit 123, a reference adjacent determining unit 124, and a switch 125.

The storing buffer 111 stores a transmitted compressed image. The lossless decoding unit 112 decodes information supplied from the storing buffer 111 and encoded by the lossless encoding unit 66 in FIG. 3 using a system corresponding to the encoding system of the lossless encoding unit 66. The inverse quantization unit 113 subjects the image decoded by the lossless decoding unit 112 to inverse quantization using a system corresponding to the quantization system of the quantization unit 65 in FIG. 3. The inverse orthogonal transform unit 114 subjects the output of the inverse quantization unit 113 to inverse orthogonal transform using a system corresponding to the orthogonal transform system of the orthogonal transform unit 64 in FIG. 3.

The output subjected to inverse orthogonal transform is decoded by being added with the prediction image supplied from the switch 125 by the computing unit 115. The deblocking filter 116 removes the block noise of the decoded image, then supplies to the frame memory 119 for storage, and also outputs to the screen sorting buffer 117.

The screen sorting buffer 117 performs sorting of images. Specifically, the sequence of frames sorted for encoding sequence by the screen sorting buffer 62 in FIG. 3 is resorted in the original display sequence. The D/A conversion unit 118 converts the image supplied from the screen sorting buffer 117 from digital to analog, and outputs to an unshown display for display.

The switch 120 reads out an image to be subjected to inter processing and an image to be referenced from the frame memory 119, outputs to the motion prediction/compensation unit 122, and also reads out an image to be used for intra prediction from the frame memory 119, and supplies to the intra prediction unit 121.

Information indicating the intra prediction mode obtained by decoding the header information is supplied from the lossless decoding unit 112 to the intra prediction unit 121. The intra prediction unit 121 generates, based on this information, a prediction image, and outputs the generated prediction image to the switch 125.

Of the information obtained by decoding the header information, the motion prediction/compensation unit 122, is supplied with the prediction mode information, motion vector information, reference frame information, and so froth, from the lossless decoding unit 112. Note that in the event that second order prediction processing is applied to the current block, the motion prediction/compensation unit 122 is also supplied with a second order prediction flag indicating that second order prediction is to be performed, and intra prediction mode information for the second order prediction, from the lossless decoding unit 122.

The motion prediction/compensation unit 122 makes reference to the second order prediction flag from the lossless decoding unit 112, and determines whether or not second order prediction processing is applied. In the event of determining that second order prediction processing is applied, the motion prediction/compensation unit 122 outputs to the second order prediction unit 123, so that the second order prediction unit 123 performs second order prediction.

Also, the motion prediction/compensation unit 122 subjects the image to motion prediction and compensation processing based on the motion vector information and reference frame information, and generates a prediction image. That is to say, the prediction image of the current block is generated using the pixel values of the reference block in the reference frame correlated with the current block by the motion vector. The motion prediction/compensation unit 122 then adds the generated prediction image and the prediction difference values from the second order prediction unit 123, and outputs to the switch 125 as a prediction image.

The second order prediction unit 123 uses the difference between the current adjacent pixels read out from the frame memory 119 and the reference adjacent pixels, and performs second order prediction. That is to say, the second order prediction unit 123 performs intra prediction for the current block in the intra prediction mode for the second order prediction form the lossless decoding unit 112, generates an intra prediction image, and outputs to the motion prediction/compensation unit 122 as prediction difference values.

On the other hand, in the event that second order prediction processing is not applied, the motion prediction/compensation unit 122 subjects the image to motion prediction and compensation processing based on the motion vector information and reference frame information, and generates a prediction image. The motion prediction/compensation unit 122 outputs the prediction image generated by the inter prediction mode to the switch 125.

The switch 125 selects the prediction image generated by the motion prediction/compensation unit 122 or intra prediction unit 121 (or prediction image and prediction difference value), and supplies to the computing unit 115.

### [Configuration Example of Second Order Prediction Unit]

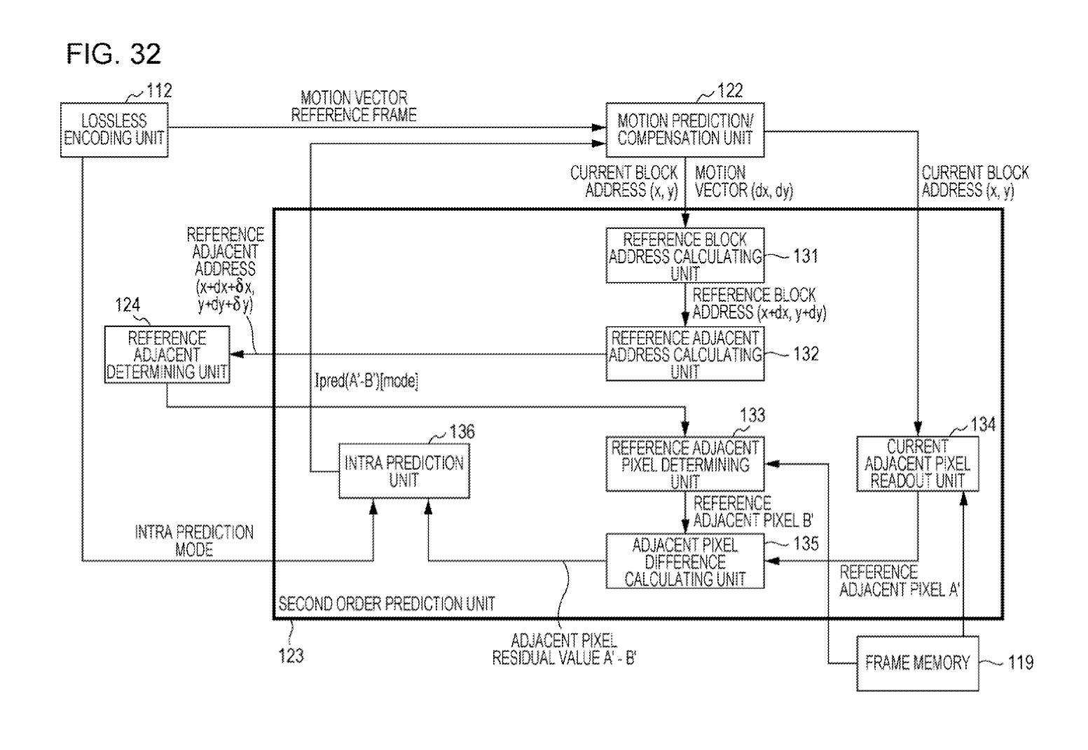

FIG. 32 is a block diagram illustrating a detailed configuration example of the second order prediction unit.

In the example in FIG. 32, the second order prediction unit 123 is configured of a reference block address calculating unit 131, a reference adjacent address calculating unit 132, a reference adjacent pixel determining unit 133, a current adjacent pixel readout unit 134, an adjacent pixel difference calculating unit 135, and an intra prediction unit 136.

Note that the reference block address calculating unit 131, reference adjacent address calculating unit 132, reference adjacent pixel determining unit 133, current adjacent pixel readout unit 134, and adjacent pixel difference calculating unit 135 in FIG. 32 perform processing basically the same as the respective reference block address calculating unit 81, reference adjacent address calculating unit 82, reference adjacent pixel determining unit 83, current adjacent pixel readout unit 84, and adjacent pixel difference calculating unit 85 in FIG. 8.

That is to say, the motion vector prediction/compensation unit 122 supplies a motion vector (dx, dy) as to a current block, to the reference block address calculating unit 131. The motion vector prediction/compensation unit 122 supplies a current block address (x, y) to the reference block address calculating unit 131 and the current adjacent pixel readout unit 134.

The reference block address calculating unit 131 determines a reference block address (x+dx, y+dy) from the current block address (x, y) and the motion vector (dx, dy) as to the current block from the motion vector prediction/compensation unit 122. The reference block address calculating unit 131 supplies the determined reference block address (x+dx, y+dy) to the reference adjacent address calculating unit 132.

The reference adjacent address calculating unit 132 calculates a reference adjacent address which is the relative address of the reference adjacent pixel, based on the reference block address (x+dx, y+dy) and the reference adjacent address calculating unit 132 supplies the relative address of the current adjacent pixel adjacent to the current block. The reference adjacent address calculating unit 132 supplies the calculated reference adjacent address (x+dx+δx, y+dy+δy) to the reference adjacent determining unit 124.

Determination results of whether or not the reference adjacent pixel exists within the image frame of the reference frame are input from the reference adjacent determining unit 124 to the reference adjacent pixel determining unit 133. In the event that the reference adjacent pixel exists within the image frame of the reference frame, the reference adjacent pixel determining unit 133 reads out the adjacent pixel defined in H.264/AVC from the frame memory 119, and stores this in an unshown built-in buffer.

On the other hand, in the event that the reference adjacent pixel does not exist within the image frame of the reference frame, the reference adjacent pixel determining unit 133 performs the terminal point processing described above with reference to FIG. 12 regarding the nonexistent adjacent pixel to determine the pixel value of the reference adjacent pixel. The reference adjacent pixel determining unit 133 then reads out the determined pixel value from the frame memory 119, and stores in the unshown built-in buffer.

The current adjacent pixel readout unit 134 uses the current block address (x, y) from the motion prediction/compensation unit 122 to read out the pixel value of the current block from the frame memory 119, and stores this in an unshown built-in buffer.

The adjacent pixel difference calculating unit 135 reads out a current adjacent pixel [A′] from the built-in buffer built into the current adjacent pixel readout unit 134, and also reads out a reference adjacent pixel [B′] corresponding to the current adjacent pixel from the built-in buffer built into the reference adjacent pixel determining unit 135. The adjacent pixel difference calculating unit 135 then calculates the difference between the current adjacent pixel [A′] and reference adjacent pixel [B′] read out from the respective built-in buffers, and stores this as an adjacent pixel difference value [A′−B′] in an unshown built-in buffer.

The intra prediction unit 136 reads out the residual [A′−B′] as to the adjacent pixel from the built-in buffer of the adjacent pixel difference calculating unit 135, and reads out a first order residual [A−B] as to the current block from the current block difference buffer 87. The intra prediction unit 136 uses the adjacent pixel difference value [A′−B′] to perform intra prediction regarding the current block in each intra prediction mode [mode] from the lossless decoding unit 112, and generates an intra prediction image Ipred(A′−B′)[mode]. The intra prediction unit 136 outputs the generated intra prediction image to the motion prediction/compensation unit 122 as difference prediction value.

Note that a circuit for performing inter prediction as second order prediction at the intra prediction unit 136 in the example in FIG. 32 can share a circuit with the intra prediction unit 122.

Next, the operations of the motion prediction/compensation unit 122 and the second order prediction unit 123 will be described.

With the motion prediction/compensation unit 122, whether or not second order prediction is being performed as to the current block is determined by a second order prediction flag decoded by the lossless decoding unit 112. In the event that second order prediction is being performed, inter prediction processing based on second order prediction is performed at the image decoding device 101, and in the event that second order prediction is not being performed, normal inter prediction processing is performed at the image decoding device 101.

Now, second order prediction at the image encoding device 51 is, as described above, processing for generating the second order residual Res_{—}2nd as in the following Expression (80).

Res_{—}2nd=(A−B)−Ipred(A′−B′)[mode] (80)

Note that Ipred( )[mode] represents, a prediction image generated by the intra prediction mode with the pixel value, of ( ) as the input.

Modifying this Expression (80), the processing at the image decoding device 101 is the processing shown in the following Expression (81).

A=Res_{—}2nd+B+Ipred(A′−B′)[mode] (81)

Now, the second order residual Res_{—}2nd is, at the image decoding device 101, a value obtained as the result of inverse quantization and inverse orthogonal transform, in other words, a value input to the computing unit 115 from the inverse orthogonal transform unit 114.

That is to say, at the image decoding device 101, a prediction difference value Ipred(B−B′)[mode) is generated by the second order prediction unit 123, a pixel value [B] of the reference block is generated by the motion prediction/compensation unit 122, and these are output to the computing unit 115. As a result, the pixel value [A] of the current block is obtained as the output of the computing unit 115, as indicated in Expression (81).

### [Description of Decoding Processing of Image Decoding Device]

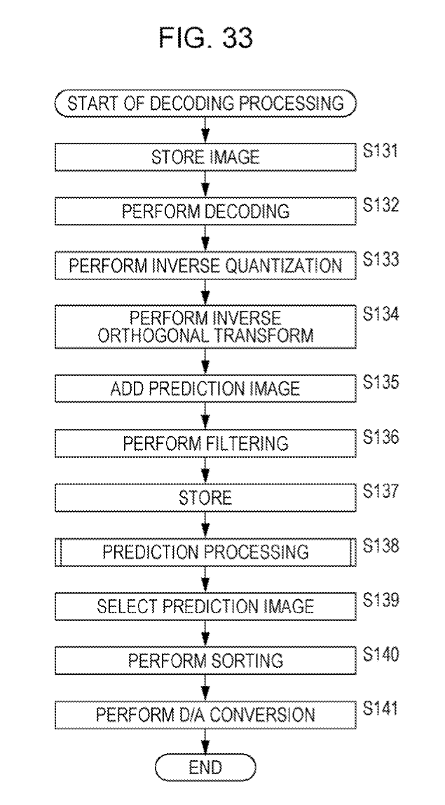

Next, the decoding processing that the image decoding device 101 executes will be described with reference to the flowchart in FIG. 33.

In step S131, the storing buffer 111 stores the transmitted image. In step S132, the lossless decoding unit 112 decodes the compressed image supplied from the storing buffer 111. Specifically, the I picture, P picture, and B picture encoded by the lossless encoding unit 66 in FIG. 3 are decoded.

At this time, if encoded, the difference motion vector information, reference frame information, prediction mode information, second order prediction flag, and information indicating intra prediction mode for second order prediction and so forth, are also decoded.

Specifically, in the event that the prediction mode information is intra prediction mode information, the prediction mode information is supplied to the intra prediction unit 121. In the event that the prediction mode information is inter prediction mode information, the difference motion vector information and reference frame information corresponding to the prediction mode information are supplied to the motion prediction/compensation unit 122. In the event that encoding has been performed by the lossless encoding unit in FIG. 3 at this time, the second order prediction flag is supplied to the motion prediction/compensation unit 122, and information indicating the intra prediction mode for second order prediction is supplied to the second order prediction unit 123.

In step S133, the inverse quantization unit 113 inversely quantizes the transform coefficient decoded by the lossless decoding unit 112 using a property corresponding to the property of the quantization unit 65 in FIG. 3. In step S134, the inverse orthogonal transform unit 114 subjects the transform coefficient inversely quantized by the inverse quantization unit 113 to inverse orthogonal transform using a property corresponding to the property of the orthogonal transform unit 64 in FIG. 3. This means that difference information corresponding to the input of the orthogonal transform unit 64 in FIG. 3 (the output of the computing unit 63) has been decoded.

In step S135, the computing unit 115 adds the prediction image selected in the processing in later-described step S141 and input via the switch 125, to the difference information. Thus, the original image is decoded. In step S136, the deblocking filter 116 subjects the image output from the computing unit 115 to filtering. Thus, block noise is removed. In step S137, the frame memory 119 stores the image subjected to filtering.

In step S138, the intra prediction unit 121 or motion prediction/compensation unit 122 each perform the corresponding image prediction processing in response to the prediction mode information supplied from the lossless decoding unit 112.

Specifically, in the event that the intra prediction mode information has been supplied from the lossless decoding unit 112, the intra prediction unit 121 performs the intra prediction processing in the intra prediction mode. In the event that the inter prediction mode information has been supplied from the lossless decoding unit 112, the motion prediction/compensation unit 122 performs the motion prediction and compensation processing in the inter prediction mode. At this time, the motion prediction/compensation unit 122 references the second order prediction flag, and inter prediction processing based on second order prediction, or normal inter prediction processing, is performed.

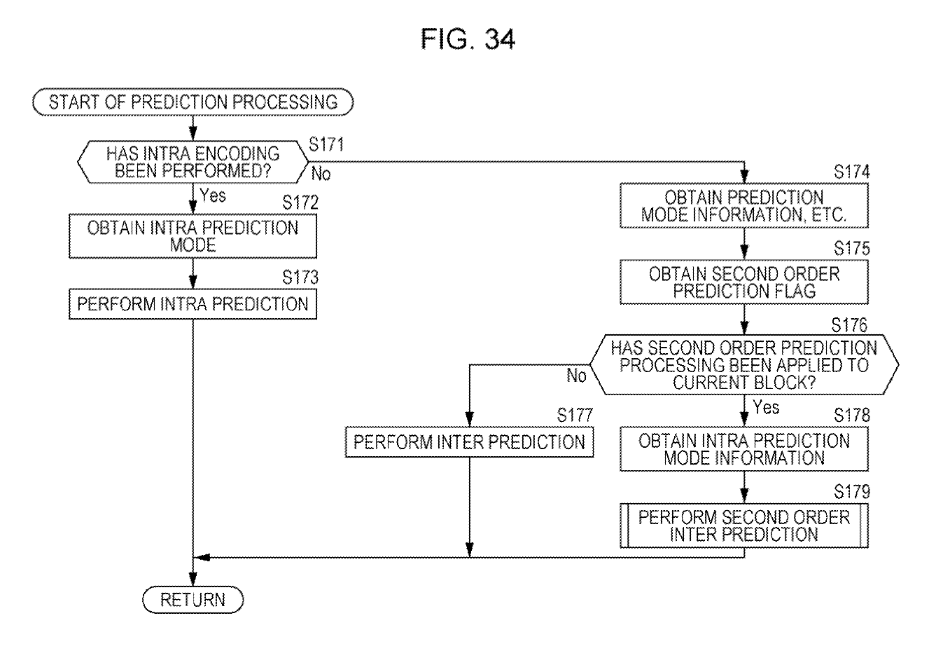

The details of the prediction processing in step S138 will be described later with reference to FIG. 34. According to this processing, the prediction image generated by the intra prediction unit 121 or the prediction image generated by the motion prediction/compensation unit 122 (or prediction image and prediction image difference value) is supplied to the switch 125.

In step S139, the switch 125 selects the prediction image. Specifically, the prediction image generated by the intra prediction unit 121 or the prediction image generated by the motion prediction/compensation unit 122 is supplied. Accordingly, the supplied prediction image is selected, supplied to the computing unit 115, and in step S134, as described above, added to the output of the inverse orthogonal transform unit 114.

In step S140, the screen sorting buffer 117 performs sorting. Specifically, the sequence of frames sorted for encoding by the screen sorting buffer 62 of the image encoding device 51 is sorted in the original display sequence.

In step S141, the D/A conversion unit 118 converts the image from the screen sorting buffer 117 from digital to analog. This image is output to an unshown display, and the image is displayed.

### [Description of Prediction Processing]

Next, the prediction processing in step S138 in FIG. 33 will be described with reference to the flowchart in FIG. 34.

In step S171, the intra prediction unit 121 determines whether or not the current block has been subjected to intra encoding. Upon the intra prediction mode information being supplied from the lossless decoding unit 112 to the intra prediction unit 121, in step S171 the intra prediction unit 121 determines that the current block has been subjected to intra encoding, and the processing proceeds to step S172.

In step S172, the intra prediction unit 121 obtains the intra prediction mode information, and in step S173 performs intra prediction.

Specifically, in the event that the image to be processed is an image to be subjected to intra processing, the necessary image is read out from the frame memory 119, and supplied to the intra prediction unit 121 via the switch 120. In step S173, the intra prediction unit 121 performs intra prediction in accordance with the intra prediction mode information obtained in step S172 to generate a prediction image. The generated prediction image is output to the switch 125.

On the other hand, in the event that determination is made in step S171 that intra encoding has not been performed, the processing proceeds to step S174.

In step S174, the motion prediction/compensation unit 122 obtains the prediction mode information and so forth from the lossless decoding unit 112.

In the event that the image to be processed is an image to be subjected to inter processing, the inter prediction mode information, reference frame information, difference motion vector information, and second order prediction flag are supplied from the lossless decoding unit 112 to the motion prediction/compensation unit 122. In this case, in step S174, the motion prediction/compensation unit 122 obtains the inter prediction mode information, reference frame information, and motion vector information.

Also, in step S175, the motion prediction/compensation unit 122 obtains the second order prediction flag, and in step S176 determines whether or not second order prediction processing is applied to the current block. In the event that determination is made in step S176 that second order prediction processing is not applied to the current block, the processing advances to step S177.

In step S177, the motion prediction/compensation unit 122 performs normal inter prediction. That is to say, in the event that the image to be processed in an image to be subjected to inter prediction processing, a necessary image is read out form the frame memory 169 and supplied to the motion prediction/compensation unit 122 via the switch 170. In step S177, the motion prediction/compensation unit 122 performs motion prediction in the inter prediction mode based on the motion vector obtained in step S174, and generates a prediction image. The generated prediction image is output to the switch 125.

In step S176, in the event that determination is made that second order prediction processing is applied to the current block, the processing advances to step S178.

Note that if second order prediction has been applied by the image encoding device 51, the information indicating the intra prediction mode relating to second order prediction is also decoded at the lossless decoding unit 112, and is supplied to the second order prediction unit 123.

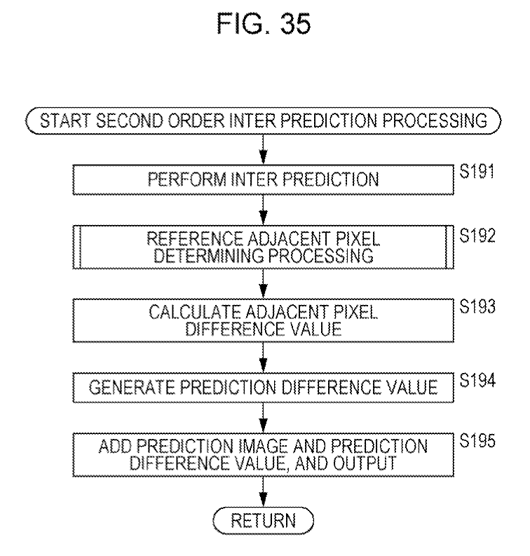

In step S178, the second order prediction unit 123 obtains the information indicating the intra prediction mode relating to second order prediction supplied from the lossless decoding unit 112, and accordingly performs second order inter prediction processing in step S179 as inter prediction processing based on second order prediction. This second order inter prediction will be described later with reference to FIG. 35.

Due to the processing in step S179, inter prediction is performed and a prediction image is generated, as well as second order prediction being performed and a prediction difference value being generated, and these are added and output to the switch 125.

Next, the second order inter prediction processing in step S179 of FIG. 34 will be described with reference to the flowchart in FIG. 35.

In step S191, the motion prediction/compensation unit 122 performs inter prediction mode motion prediction based on the motion vector obtained in step S174 in FIG. 34, and generates an inter prediction image. That is top say, due to the processing of step S191, a prediction image of the current block is generated using the pixel values of the reference block in the reference frame correlated to the current block by the motion vector.

Also, the motion prediction/compensation unit 122 supplies the current block address (x, y) and motion vector (dx, dy) to the reference block address calculating unit 131, and supplies the current block address (x, y) to the current adjacent pixel readout unit 134.

In step S192, the second order prediction unit 123 and reference adjacent determining unit 124 perform reference adjacent pixel determining processing. This reference adjacent pixel determining processing in detail is the same as the processing described above with reference to FIG. 29, so description thereof will be omitted since it would be redundant.

Due to the processing in step S192, determination is made regarding whether reference adjacent pixels adjacent to the reference block exist within the image frame of the reference frame, and terminal point processing is performed according to the determination results thereof, thereby determining the pixel values of the reference adjacent pixels. The pixel values of the reference adjacent pixels that have been determined are stored in a built-in buffer of the reference adjacent pixel determining unit 133.

Also, the current adjacent pixel readout unit 134 uses the current block address (x, y) from the motion prediction/compensation unit 122 to read out the pixel values of the current block from the frame memory 119, and stores these in an unshown built-in buffer.

The adjacent pixel difference calculating unit 135 reads out a current adjacent pixel [A′] from the built-in buffer built into the current adjacent pixel readout unit 134, and also reads out a reference adjacent pixel [B′] corresponding to the current adjacent pixel from the built-in buffer built into the reference adjacent determining unit 133. In step S193 the adjacent pixel difference calculating unit 135 calculates an adjacent pixel difference value [A′−B′] which is the difference between the current adjacent pixel [A′] and reference adjacent pixel [B′] read out from the respective built-in buffers, and stores this in an unshown built-in buffer.

In step S194 the intra prediction unit 136 performs intra prediction processing using difference in the intra prediction mode for second order prediction that has been obtained in step S178 in FIG. 34, and generates a prediction value Ipred(A′−B′)[mode].

That is to say, the intra prediction unit 136 reads out the adjacent pixel difference value [A′−B′] from the built-in buffer of the adjacent pixel difference calculating unit 135. The intra prediction unit 136 then uses the adjacent pixel difference value [A′−B′] that has been read out to perform intra prediction regarding the current block in the obtained intra prediction mode [mode], and generates a prediction difference value Ipred(A′−B′)[mode]. The generated prediction difference value is output to the motion prediction/compensation unit 122.

In step S195, the motion prediction/compensation unit 122 adds the inter prediction image generated in step S191 and the prediction difference value from the intra prediction unit 136, and outputs this to the switch 125 as a prediction image.

In step S139 in FIG. 33, this inter prediction image and prediction difference value are output by the switch 125 to the computing unit 115 as a prediction image. The inter prediction image and prediction difference value are added to the difference information from the inverse orthogonal transform unit 114 by the computing unit 115 in step S135 in FIG. 33, thereby decoding the image of the current block.

As described above, with the image encoding device 51 and image decoding device 101, terminal processing is performed in the event that reference adjacent pixels are outside the image frame, to deterring the reference adjacent pixels, so second order prediction can be performed even in the event that the reference adjacent pixels are outside the image frame.

Accordingly, encoding efficiency can be improved.

Note that in the above description, description has been made of an example of intra 4×4 prediction mode in the H.264/AVC format, but the present invention is not restricted to this, and is applicable to all encoding devices and decoding devices which perform block-based motion prediction/compensation. Also, the present invention is applicable to intra 8×8 prediction mode, intra 16×16 prediction mode, and intra prediction mode on color difference signals.

Description has been made so far with the H.264/AVC format employed as an encoding format, but other encoding formats/decoding formats may be employed.

Note that the present invention may be applied to an image encoding device and an image decoding device used at the time of receiving image information (bit streams) compressed by orthogonal transform such as discrete cosine transform or the like and motion compensation via a network medium such as satellite broadcasting, a cable television, the Internet, a cellular phone, or the like, for example, as with MPEG, H.26x, or the like. Also, the present invention may be applied to an image encoding device and an image decoding device used at the time of processing image information on storage media such as an optical disc, a magnetic disk, and flash memory. Further, the present invention may be applied to a motion prediction compensation device included in such an image encoding device and an image decoding device and so forth.

The above-described series of processing may be executed by hardware, or may be executed by software. In the event of executing the series of processing by software, a program making up the software thereof is installed in a computer. Here, examples of the computer include a computer built into dedicated hardware, and a general-purpose personal computer whereby various functions can be executed by various types of programs being installed thereto.

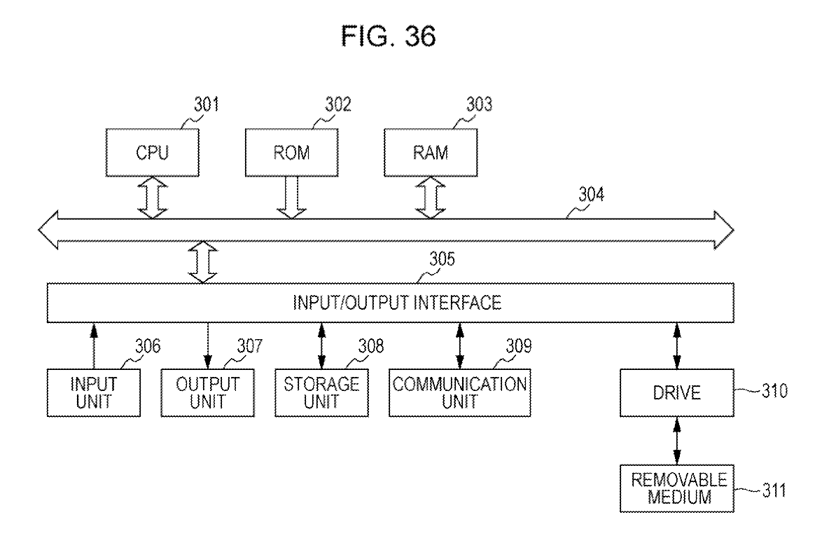

FIG. 36 is a block diagram illustrating a configuration example of the hardware of a computer which executes the above-described series of processing using a program.

With the computer, a CPU (Central Processing Unit) 301, ROM (Read Only Memory) 302, and RAM (Random Access Memory) 303 are mutually connected by a bus 304.

Further, an input/output interface 305 is connected to the bus 304. An input unit 306, an output unit 307, a storage unit 308, a communication unit 309, and a drive 310 are connected to the input/output interface 305.

The input unit 306 is made up of a keyboard, a mouse, a microphone, and so forth. The output unit 307 is made up of a display, a speaker, and so forth. The storage unit 308 is made up of a hard disk, nonvolatile memory, and so forth. The communication unit 309 is made up of a network interface and so forth. The drive 310 drives a removable medium 311 such as a magnetic disk, an optical disc, a magneto-optical disk, semiconductor memory, or the like.

With the computer thus configured, for example, the CPU 301 loads a program stored in the storage unit 308 to the RAM 303 via the input/output interface 305 and bus 304, and executes the program, and accordingly, the above-described series of processing is performed.

The program that the computer (CPU 301) executes may be provided by being recorded in the removable medium 311 serving as a package medium or the like, for example. Also, the program may be provided via a cable or wireless transmission medium such as a local area network, the Internet, or digital broadcasting.

With the computer, the program may be installed in the storage unit 308 via the input/output interface 305 by mounting the removable medium 311 on the drive 310. Also, the program may be received by the communication unit 309 via a cable or wireless transmission medium, and installed in the storage unit 308. Additionally, the program may be installed in the ROM 302 or storage unit 308 beforehand.

Note that the program that the computer executes may be a program wherein the processing is performed in the time sequence along the sequence described in the present Specification, or may be a program wherein the processing is performed in parallel or at necessary timing such as when call-up is performed.

The embodiments of the present invention are not restricted to the above-described embodiment, and various modifications may be made without departing from the essence of the present invention.

### REFERENCE SIGNS LIST

51 image encoding device
66 lossless encoding unit
74 intra prediction unit
75 motion prediction/compensation unit
76 second order prediction unit
77 reference adjacent determining unit
78 prediction image selecting unit
81 reference block address calculating unit
82 reference adjacent address calculating unit
83 reference adjacent pixel determining unit
84 current adjacent pixel readout unit
85 adjacent block difference calculating unit
86 intra prediction unit
87 current pixel difference buffer
101 image decoding device
112 lossless decoding unit
121 intra prediction unit
122 motion prediction/compensation unit
123 second order prediction unit
124 reference adjacent determining unit
125 switch
131 reference block address calculating unit
132 reference adjacent address calculating unit
133 reference adjacent pixel determining unit
134 current adjacent pixel readout unit
135 adjacent pixel difference calculating unit
136 intra prediction unit

1. An image processing device comprising:
determining means for determining, using a relative address of a current adjacent pixel which is adjacent to a current block in a current frame, whether or not a reference adjacent pixel adjacent to a reference block in said reference frame exists within an image frame of said reference frame;
terminal point processing means for performing terminal point processing as to said reference adjacent pixel in the event that determination is made by said determining means that said reference adjacent pixel does not exist within said image frame;
second order prediction means for generating second order different information, by performing prediction between difference information between said current block and said reference block, and difference information between said current adjacent pixel and said reference adjacent pixel regarding which terminal point processing has been performed by said terminal point processing means; and
encoding means for encoding said second order different information generated by said second order prediction means.

2. The image processing device according to claim 1, further comprising calculating means for calculating a relative address (x+dx+δx, y+dy+δy) of said reference adjacent pixel, with an address (x, y) of said current block, motion vector information (dx, dy) by which said current block refers to said reference block, and a relative address (δx, δy) of said current adjacent pixel;
wherein said determining means determine whether or not the relative address (x+dx+δx, y+dy+δy) of said reference adjacent pixel calculated by said calculating means exists within said image frame.

3. The image processing device according to claim 2, wherein, in the event that pixel values are represented as n bits, said terminal point processing means perform said terminal point processing such that the pixel value of said reference adjacent pixel regarding which
x+dx+δx<0 or y+dy+δy<0
holds is 2ⁿ⁻¹.

4. The image processing device according to claim 2, wherein said terminal point processing means perform said terminal point processing using a pixel value pointed to by an address (WIDTH−1, y+dy+δy) as the pixel value of said reference adjacent pixel in the event that
x+dx+δx>WIDTH−1
holds, where WIDTH represents the number of pixels in the horizontal direction of said image frame.

5. The image processing device according to claim 2, wherein said terminal point processing means perform said terminal point processing using a pixel value pointed to by an address (x+dx+δx, HEIGHT−1) as the pixel value of said reference adjacent pixel in the event that
y+dy+δy>HEIGHT−1
holds, where HEIGHT represents the number of pixels in the vertical direction of said image frame.

6. The image processing device according to claim 2, wherein said terminal point processing means perform said terminal point processing using a pixel value pointed to by an address (WIDTH−1, HEIGHT−1) as the pixel value of said reference adjacent pixel in the event that
x+dx+δx>WIDTH−1 and y+dy+δy>HEIGHT−1
hold, where WIDTH represents the number of pixels in the horizontal direction of said image frame and HEIGHT represents the number of pixels in the vertical direction of said image frame.

7. The image processing device according to claim 2, wherein said terminal point processing means perform said terminal point processing in which pixel values are generated by mirror processing, symmetrically at the boundary of said image frame as to said reference adjacent pixels not existent in said image frame.

8. The image processing device according to claim 1, said second order prediction means further including:
intra prediction means for performing prediction using difference information between said current adjacent pixel and said reference adjacent pixel regarding which terminal processing has been performed by said terminal point processing means, to generate an intra prediction image as to said current block; and
second order difference generating means for differencing the difference information between said current block and said reference block, and said intra prediction image generated by said intra prediction means, to generate said second order difference information.

9. The image processing device according to claim 1, in the event that said determining means determine that said reference adjacent pixel exists within said image frame, said second order prediction means perform prediction between difference information between said current block and said reference block, and difference information between said current adjacent pixel and said reference adjacent pixel.

10. An image processing method, comprising the step of:
an image processing device
determining, using a relative address of a current adjacent pixel which is adjacent to a current block in a current frame, whether or not a reference adjacent pixel adjacent to a reference block in said reference frame exists within an image frame of said reference frame,
performing terminal point processing as to said reference adjacent pixel in the event that determination is made that said reference adjacent pixel does not exist within said image frame,
generating second order different information, by performing prediction between difference information between said current block and said reference block, and difference information between said current adjacent pixel and said reference adjacent pixel regarding which terminal point processing has been performed, and
encoding said generated second order different information.

11. An image processing device comprising:
decoding means for decoding an image of a current block in an encoded current frame;
determining means for determining, using a relative address of a current adjacent pixel which is adjacent to said current block, whether or not a reference adjacent pixel adjacent to a reference block in said reference frame exists within an image frame of said reference frame;
terminal point processing means for performing terminal point processing as to said reference adjacent pixel in the event that determination is made by said determining means that said reference adjacent pixel does not exist within said image frame;
second order prediction means for generating a prediction image, by performing second order prediction using difference information between said current adjacent pixel and said reference adjacent pixel regarding which terminal processing has been performed by said terminal point processing means; and
computing means for adding the image of said current block, said prediction image generated by said second order prediction means, and the image of said reference block, to generate a decoded image of said current block.

12. The image processing device according to claim 11, further comprising calculating means for calculating a relative address (x+dx+δx, y+dy+δy) of said reference adjacent pixel, with an address (x, y) of said current block, motion vector information (dx, dy) by which said current block refers to said reference block, and a relative address (δx, δy) of said current adjacent pixel;
wherein said determining means determine whether or not the relative address (x+dx+δx, y+dy+δy) of said reference adjacent pixel calculated by said calculating means exists within said image frame.

13. The image processing device according to claim 12, wherein, in the event that pixel values are represented as n bits, said terminal point processing means perform terminal point processing such that the pixel value of said reference adjacent pixel regarding which
x+dx+δx<0 or y+dy+δy<0
holds is 2ⁿ⁻¹.

14. The image processing device according to claim 12, wherein said terminal point processing means perform said terminal point processing using a pixel value pointed to by an address (WIDTH−1, y+dy+δy) as the pixel value of said reference adjacent pixel in the event that
x+dx+δx>WIDTH−1
holds, where WIDTH represents the number of pixels in the horizontal direction of said image frame.

15. The image processing device according to claim 12, wherein said terminal point processing means perform said terminal point processing using a pixel value pointed to by an address (x+dx+δx, HEIGHT−1) as the pixel value of said reference adjacent pixel in the event that
y+dy+δy>HEIGHT−1
holds, where HEIGHT represents the number of pixels in the vertical direction of said image frame.

16. The image processing device according to claim 12, wherein said terminal point processing means perform said terminal point processing using a pixel value pointed to by an address (WIDTH−1, HEIGHT−1) as the pixel value of said reference adjacent pixel in the event that
x+dx+δx>WIDTH−1 and y+dy+δy>HEIGHT−1
hold, where WIDTH represents the number of pixels in the horizontal direction of said image frame and HEIGHT represents the number of pixels in the vertical direction of said image frame.

17. The image processing device according to claim 12, wherein said terminal point processing means perform said terminal point processing in which pixel values are generated by mirror processing, symmetrically at the boundary of said image frame as to said reference adjacent pixels not existent in said image frame.

18. The image processing device according to claim 11, said second order prediction means further including:
prediction image generating means for generating a prediction image by performing second order prediction using difference information between said current adjacent pixel and said reference adjacent pixel regarding which terminal processing has been performed by said terminal point processing means.

19. The image processing device according to claim 11, in the event that said determining means determine that said reference adjacent pixel exists within said image frame, said second order prediction means perform prediction using difference information between said current adjacent pixel and said reference adjacent pixel.

20. An image processing method, comprising the step of:
an image processing device
decoding an image of a current block in an encoded current frame,
determining, using a relative address of a current adjacent pixel which is adjacent to said current block, whether or not a reference adjacent pixel adjacent to a reference block in said reference frame exists within an image frame of said reference frame,
performing terminal point processing as to said reference adjacent pixel in the event that determination is made that said reference adjacent pixel does not exist within said image frame,
generating a prediction image, by performing second order prediction using difference information between said current adjacent pixel and said reference adjacent pixel regarding which terminal processing has been performed, and
adding the image of said current block, said prediction image generated by said second order prediction means, and the image of said reference block, to generate a decoded image of said current block.
